(19) United States
(12) Patent Application Publication
(10) Pub. No.: US 2012/0248793 A1
(43) Pub. Date: Oct. 4, 2012

(54) Mechanical Closure Having a Locking Device

(75) Inventor: Joachim Fiedler, Hannover (DE)

(73) Assignee: FIDLOCK GMBH, Hannover (DE)

(21) Appl. No.: 13/390,759

(22) PCT Filed: Aug. 23, 2010
(86) PCT No.: PCT/EP10/62262

§ 371 Date: Jun. 20, 2012

(30) Foreign Application Priority Data
Aug. 24, 2009 (DE) 102009038370.0
Jan. 29, 2010 (DE) 102010006798.9
Jul. 13, 2010 (DE) 202010010300.2

(51) Int. Cl. E05C 1/12; E05B 35/00; E05B 37/00; E05C 19/16

(52) U.S. Cl. 292/163; 292/137; 70/344; 70/330

(57) ABSTRACT

The invention relates to a lock device, having a first connecting module and a second connecting module. The first connecting module can here be arranged in a closing direction on the second connecting module and is mechanically catch-lockingly engaged in a closing position with the second connecting module, and the first connecting module can be detached from the second connecting module by a movement of the first connecting module or of a part of the first connecting module in an opening direction, which differs from the closing direction. Here, a locking device (7; 9, 9a-f) is provided to prevent a movement of the first connecting module (1) or of the part (1a) of the first connecting module (1) in the opening direction (Y), when the first connecting module (1) and the second connecting module (2) are positioned in the closing position, wherein the locking device (7, 9, 9a-f; 100,101, 102; 206, 207) can be unlocked to move the first connecting module (1) or the part (1a) of the first connecting module (1) in the opening direction (Y).

The invention relates to a lock device according to the preamble of claim 1.

Such a lock device has a first connecting module and a second connecting module, of which the first connecting module can be arranged in a closing direction on the second connecting module and is then mechanically catch-lockingly engaged in a closing position with the second connecting module.

The lock device can be opened in that the first connecting module can be detached from the second connecting module by terminating the catch locking engagement by a movement of the first connecting module, or of a part of the first connecting module serving as actuating element, in an opening direction, which differs from the closing direction.

In a lock device known from WO 2008/006357 A2 a first connecting module and a second connecting module each have for example one or multiple magnets which attractingly act between the first connecting module and the second connecting module in such a way that the first connecting module catch-lockingly engages with the second connecting module. Locking the lock takes place here in a closing direction which is directed essentially perpendicular to the planes of extension of the first connecting module and the second connecting module. As the first connecting module or an actuating element of the first connecting module is turned or shifted relative to the second connecting module, the catch locking elements of the first connecting module and of the second connecting module come out of engagement, wherein by the movement at the same time the magnetic attracting force between the first connecting module and the second connecting module—caused by a movement of the magnets relative to each other—is weakened, so that the first connecting module can be detached from the second connecting module. As, to support the closing movement, magnets are provided whose effect weakens upon opening, both the closing process and the opening process can take place in an easy and haptically pleasant manner.

In a lock device known from WO 2009/010049 A2, in which a first connecting module and a second connecting module can, magnetically supported, be catch-lockingly brought into engagement with each other, releasing the catch locking engagement takes place by a shifting or turning movement of the first connecting module, or of a part of the first connecting module, relative to the second connecting module, wherein by the shifting or turning movement a catch locking element of the one connecting module runs up onto a slope of the other connecting module and is thereby pushed out of engagement with an allocated catch locking element of the other connecting module, so that the catch locking engagement of the first connecting module and the second connecting module is terminated.

The lock devices of WO 2008/006 357 A2 and of WO 2009/01 00 49 A2 have in common that the catch-locking locking of the first connecting module with the second connecting module can be released in the closing position by a movement of the first connecting module, or of a part of the first connecting module (in the form of an actuating element), relative to the second connecting module in an opening direction, which differs from the closing direction to establish the locking. As a user in a suitable manner actuates the first connecting module, or an actuating element provided on said connecting module, by moving it in the opening direction, the first connecting module is detached from the second connecting module. Thereby, releasing the locking can take place essentially unobstructed and free by suitable actuation of the first connecting module or of the part of the first connecting module (in the form of an actuating element).

It is desirable that releasing the lock device can only take place when this is also intended. In particular, it can also be desirable, to make possible a release only under specific circumstances and by specific persons, for example to provide an anti-theft protection.

It is the object of the present invention to provide a lock device of the kind mentioned in the beginning, which in a simple and user-friendly manner is secured against an unintended release.

This object is achieved by a subject-matter having the features of claim 1.

Here, in a lock device of the kind mentioned in the beginning, a locking device is provided to prevent a movement of the first connecting module, or of the part of the first connecting module, in the opening direction when the first connecting module and the second connecting module are positioned in the closing position, wherein the locking device can be unlocked to move the first connecting module or the part of the first connecting module in the opening direction.

It is the idea of the present invention to provide a locking device, which prevents an unintended movement of the first connecting module, or of the part of the first connecting module, for releasing the lock device. The locking device in the closing position thereby retains the first connecting module, or the part of the first connecting module which is to be actuated to release the lock device, so that it cannot be moved in the opening direction and thereby the lock device also cannot be opened. The locking device is here designed in such a way that it can be unlocked, and when the locking device is unlocked a movement of the first connecting module or the part of the first connecting module in the opening direction is possible, so that the catch locking engagement of the first connecting module with the second connecting module can be terminated and the first connecting module can be detached from the second connecting module.

The locking device represents a safeguarding measure which prevents an unintended release of the lock device. In this manner, the lock device securely holds together the first connecting module and the second connecting module and guarantees a secure connection also during operation and under strain.

The phrase, the opening direction differs from the closing direction, shall presently be understood to mean that the opening direction points in another direction than the closing direction and is not directed parallel to it. In particular, the opening direction is thus not directed contrary to the closing direction.

The movement of the first connecting module, or of the part of the first connecting module which is to be actuated to open the lock device, can particularly be a shifting movement transverse to the closing direction, a rotation movement in a plane transverse to the closing direction or a pivoting movement on a rotation axis transverse to the closing direction. It is essential herein that the opening direction (which can also be a direction of rotation) differs from the closing direction, so that the connection of the first connecting module to the second connecting module to close the lock device takes place in the closing direction, the opening, however, is caused by a movement in an opening direction different from the closing direction, for example running transverse to the closing direction.

In the closing position the first connecting module and the second connecting module are mechanically catch-lockingly engaged with each other. For this purpose, at least one spring lock element, i.e. an elastically mounted locking element, is provided on the first connecting module or on the second connecting module, which engages with at least one blocking piece on the other connecting module to form a spring catch locking. The spring lock element can for example be an elastic catch locking element as a kind of clip. The blocking piece can for example be a locking catch, which the spring lock element positive-lockingly acts on.

Additionally, magnetic means can be provided, which, to support the transfer of the first connecting module into the closing position, cause a magnetic attracting force between the first connecting module and the second connecting module. By providing the magnetic means the lock device is lockable in an easy and haptically pleasant manner, in that the closing process upon attaching the first connecting module onto the second connecting module is magnetically supported and the mechanical catch locking engagement is established in an automatic manner.

The spring catch locking can be catch-lockingly engaged by arranging the first connecting module in the closing direction on the second connecting module, wherein herein the at least one spring lock element comes into positive-locking engagement with the at least one blocking piece. Upon establishing the closing position the first connecting module and the second connecting module are attracted by the magnetic means, so that the spring catch locking can advantageously engage largely automatically.

But the lock device can also act purely mechanically—and thus have no magnetic means—and be lockable by manually attaching the connecting modules onto each other and by applying a compressive force in the closing direction.

Releasing the lock device takes place in that the first connecting module, or the part of the first connecting module which is to be actuated, is moved relative to the second connecting module in such a way that the at least one spring lock element and the at least one blocking piece of the spring catch locking come out of engagement.

In a first embodiment the at least one spring lock element and the at least one blocking piece of the spring catch locking can for this purpose be shifted relative to each other in such a way that the at least one spring lock element along the opening direction gets out of range of the at least one blocking piece, so that the catch locking engagement is terminated. The idea herein is that the spring lock element is shifted as far in the opening direction relative to the blocking piece until it gets out of range of the blocking piece and is thereby no longer held positive-lockingly by the blocking piece. In this shifted position, the catch locking engagement is thereby terminated. Shifting the spring lock element relative to the blocking piece can take place by a tangential, linear movement or also by a turning movement of the first connecting module, or of the part of the first connecting module which is to be actuated, relative to the second connecting module.

In an alternative embodiment it can also be provided that the at least one spring lock element is shifted relative to the at least one blocking piece in such a way that the at least one spring lock element is pushed out of engagement with the at least one blocking piece by running up onto a run-up slope transverse to the opening direction. The idea is here, that upon moving the spring lock element in the opening direction the spring lock element runs up onto a slope, which acts upon the spring lock element in such a way that said spring lock element is pushed out of engagement with the at least one blocking piece transverse to the opening direction, so that the positive-locking engagement of the spring lock element with the blocking piece is terminated. This can, yet again, take place by a linear shifting movement or by a turning movement of the first connecting module, or of the part of the first connecting module which is to be actuated, relative to the second connecting module.

In a third embodiment the at least one spring lock element and the at least one blocking piece of the spring catch locking are designed as a kind of thread, so that by turning the first connecting module, or the part of the first connecting module which is to be actuated, relative to the second connecting module the at least one spring lock element and the at least one blocking piece can be screwed out of engagement. The spring lock element and the blocking piece each have for this purpose at least one thread groove, which in the closing direction can in a spring-elastic manner be catch-lockingly brought into engagement with each other. As the spring lock element and the blocking piece are then screwed apart, the spring lock element can be brought out of engagement with the blocking piece, so that the catch locking engagement is terminated and the first connecting module can be taken away from the second connecting module.

Advantageously the magnetic means, used where applicable, are designed in such a way that by the movement of the first lock part, or of the part of the first lock part which is to be actuated, in the opening direction at the same time also the magnetic means are moved relative to each other in such a way that the magnetic attracting force between the first connecting module and the second connecting module is weakened. For the realization of the magnetic means in this context at least one magnet each, or on the one hand at least one magnet and on the other hand at least one magnetic, for example ferromagnetic, anchor (e.g. in the form of a steel or iron sheet), can be arranged on the first connecting module and on the second connecting module respectively. By the movement of the first connecting module, or of the part of the first connecting module which is to be actuated, in the opening direction then also the at least one magnet or the magnetic anchor of the first connecting module and the at least one magnet or the magnetic anchor of the second connecting module are moved relative to each other in such a way that the magnetic attracting force weakens.

When for example a magnet each is provided on the first connecting module and on the second connecting module respectively, to close the lock device these lie frontally opposite to each other with different poles so that they attract each other and establish the catch locking engagement of the first connecting module with the second connecting module. By moving the first connecting module, or the part of the first connecting module which is to be actuated, in the opening direction then for example the magnets can be moved tangentially relative to each other, so that they no longer lie frontally opposite to each other and the magnetic attracting force between them is weakened.

When on each connecting module two or more magnets are used, it is also conceivable that by the movement of the first connecting module, or of the part of the first connecting module which is to be actuated, like poles of the magnets are approximated to each other, so that the magnetic attracting force can, where applicable, even be reversed into a magnetic force of repulsion to thereby also magnetically support the opening of the lock device.

In an advantageous embodiment, furthermore, restoring means are provided to transfer the first connecting module, or the part of the first connecting module which is to be actuated, into a position in which the first connecting module can be catch-lockingly engaged with the second connecting module. The restoring means, for example formed by a mechanical spring, have the effect that upon attaching the first connecting module onto the second connecting module these are in due manner adjusted relative to each other in such a way that—with the support of the magnetic means—the catch locking engagement can be established. In other words, by the effect of the restoring means the first connecting module, or the part of the first connecting module which is to be actuated, is returned again from the position, into which it had been moved in the opening direction for opening, so that by attaching the first connecting module onto the second connecting module the lock device can readily be closed again.

In an advantageous embodiment these restoring means can also be realized by the magnetic means, so that additional means for example in the form of a mechanical spring are not required. The magnetic means, by the magnetic attracting force acting between their magnetic elements, herein have the effect that the first connecting module or its parts, which are provided for the catch locking engagement, automatically come into their position required for the catch locking engagement.

The locking device can for example have at least one locking element, movably arranged on the first connecting module or on a part of the first connecting module, to engage with a recess on the second connecting module or on a second part of the first connecting module in such a way that a movement of the first connecting module, or of the part of the first connecting module which is to be actuated, in the opening direction to detach the first connecting module from the second connecting module is prevented. The locking element can for example be designed as a locking bolt, which lockingly connects the first connecting module to the second connecting module, so that the first connecting module cannot be moved relative to the second connecting module and, thereby, opening the lock device is impossible.

It is also possible that the locking element lockingly connects a part of the first connecting module, which is to be actuated to open the lock device, to a fixed part of the first connecting module, so that the part which is to be actuated cannot be moved, for example cannot be turned or shifted, in the opening direction. It is essential herein that the locking element prevents a movement of the part of the first connecting module, which is to be actuated to open the lock device, so that opening the lock device is only possible when the locking element is unlocked, that is, no longer engages with the allocated recess.

For a secure locking, multiple locking elements can be provided which are to be actuated in an unlocking manner to open the lock device.

In an advantageous embodiment the locking device is designed for actuation by means of a key or a numerical code. Unlocking the locking device takes place then only by using a key or by entering a numerical code, so that the locking device at the same time also provides an anti-theft protection, in the scope of which unauthorized persons are unable to open the lock device.

It is furthermore possible and advantageous that the locking device is designed to automatically come into its locked position upon arranging the first connecting module on the second connecting module, so that in the closing position the first connecting module catch-lockingly engages with the second connecting module in an automatic manner and at the same time the lock device is locked in such a way that opening the lock device is only possible by unlocking the locking device. The locking elements of the locking device can for this purpose for example be pre-loaded by mechanical springs, so that upon establishing the closing state the locking elements automatically come into engagement with the allocated recesses in a locking manner.

Instead of forming the locking device by a separate locking element, movably arranged on the first connecting module, which has to be unlocked to unlock the lock device, in an alternative embodiment it can also be provided that the locking device can be unlocked by moving the first connecting module or a part of the first connecting module in an unlocking direction. The unlocking direction herein differs from the opening direction and is not directed parallel to it. For example, the unlocking direction can be directed transverse to the opening direction or, when the movement in the opening direction is configured as a linear movement, can be configured as a direction of rotation. It is also possible—but not imperative—that the unlocking direction differs both from the opening direction and from the closing direction and is not directed parallel to either of these.

Unlocking the lock device thereby takes place not by actuation of a separate locking elements, but by a movement of the first connecting module or of a part of the first connecting module, so that the locking device can be integrally formed with the first connecting module or a part of the first connecting module. The idea herein is to develop for the unlocking movement a further degree of freedom for the movability of the first connecting module or of a part of the first connecting module. In this way, the first connecting module can be attached onto the second connecting module in the closing direction, can be detached from the second connecting module by a movement in the opening direction, differing from the closing direction, for example directed transverse to the closing direction, but for this purpose has to be previously unlocked by a movement in the unlocking direction, differing at least from the opening direction.

In a concrete embodiment the locking device can be formed by a locking element, fixedly arranged on the first or the second connecting module, which in a locked, closed state of the lock device engages with a groove on the other of first and second connecting module. The opening direction can herein for example be directed transverse to the closing direction and the unlocking direction can be designed as a direction of rotation on the closing direction, wherein by turning the first connecting module or a part of the first connecting module in the unlocking direction the locking element can be brought out of engagement with the groove, to be able to move the first connecting module or the part of the first connecting module in the opening direction relative to the second connecting module and to thereby be able to open the lock device.

To ensure that upon closing the lock device and transferring the connecting modules into their closed, locked state the locking device securely locks, restoring means can be provided, which have the effect that the first connecting module or the part of the first connecting module, upon attachment onto the second connecting module, comes into a position in which it catch-lockingly engages with the second connecting module, and at the same time the locking device is locked. This return can, for example, be realized by additional spring means, pre-loading the first connecting module or the part of the first connecting module in a locked position, or by the magnetic means, which have the effect that the first connecting module or the part of the first connecting module, upon attachment onto the second connecting module, is for example turned in such a way that the locking device is automatically locked.

For example, the magnetic means can be formed by two magnets, identical in construction and not rotationally symmetric—for example rectangular—which stand opposite to each other with unlike poles and thereby attract each other and try to assume a position, in which both magnets stand congruently opposite to each other. When using rectangular magnets there are for example two positions, turned relative to each other by 180°, in which the magnets stand attracting congruently opposite to each other. These two positions then correspond to positions of the first (or the part of the first) connecting module and the second connecting module relative to each other, in which the first and the second connecting module can be locked with each other.

Alternatively, the magnetic means can also be polarized in such a way that magnets on the first connecting module and magnets on the second connecting module stand opposite to each other with multiple polarities and upon attaching the connecting modules onto each other automatically adjust into a preferential position, in which a locking can take place.

In another concrete embodiment the first connecting module or a part of the first connecting module can be pivotable on a rotation axis, directed transverse to the closing direction, in the opening direction to open the lock device relative to the second connecting module. In this case the locking device in the locked state prevents a pivoting movement of the first connecting module or of a part of the first connecting module, wherein the locking device is for example formed by a locking element, arranged on the one of first and second connecting module, and an engaging element, arranged on the other of first and second connecting module and in the locked state engaging with the locking element, and the locking device can be unlocked by a movement of the first connecting module or of a part of the first connecting module in an unlocking direction, differing from the opening direction.

In this case the first connecting module is in a closing direction attached onto the second connecting module and can be detached again from the second connecting module by moving at least a part of the first connecting module in a pivoting direction corresponding to the opening direction. The unlocking direction can in this case for example be directed transverse to or contrary to the closing direction and thereby differs from the opening direction.

In turn, restoring means can be realized by additional spring means or by the magnetic means provided anyway, which have the effect that the first connecting module or the part of the first connecting module upon closing the lock device automatically comes into a position in which it, upon attaching the connecting modules onto each other, comes into its locked state and can only be opened by a movement in the unlocking direction and a subsequent movement in the opening direction.

As the unlocking of the locking device takes place by a movement of the first connecting module or of a part of the first connecting module, the opening process divides into two movement components of the first connecting module or of a part of the first connecting module. First, to open the lock device, the first connecting module or a part of the first connecting module has to be moved by a predetermined distance in the unlocking direction to in this manner release the locking device. Afterwards, the first connecting module or the part of the first connecting module is then moved in the opening direction so that the mechanical catch locking engagement between the first connecting module and the second connecting module can be terminated and the connecting modules can thereby be separated from each other. The result is a haptically pleasant opening process, which at the same time guarantees a secure hold in the closed position of the lock device and, thereby, a secure connection of components which are to be connected.

In an embodiment the lock device is for example made of a first connecting module and a second connecting module, wherein
in the first connecting module at least one magnet and in the second connecting module at least one anchor or a second magnet is arranged,
in the first connecting module a spring lock element and in the second connecting module a blocking piece is arranged, which together form a spring catch locking,
during the closing process between the first connecting module and the second connecting module the spring catch locking is closed by the attraction of magnet and anchor or second magnet,
to open, magnet and anchor are shifted laterally or tangentially, wherein
   additionally, spring lock element and blocking piece are moved against each other, so that the spring catch locking is laterally bypassed during the opening process without the spring lock element being pushed aside, or
   the spring lock element is gradually pushed aside during a lateral shifting by means of a force-deflecting slope, or
   spring lock element and blocking piece are designed thread-like, catch-lockingly engage upon closing and are opened upon opening by screwing,
an unlockable locking device is provided, which prevents the lateral or tangential opening movement between spring lock element and blocking piece, but does not impede the engaging movement of the first connecting module and the second connecting module.

The advantage of this lock device is that opening cannot take place unintended, as two actuations are needed: Unlocking and lateral shifting or rotating to open. On the other hand, the lock device closes in a very pleasant manner, as the magnet closes the catch locking automatically. After the engagement the locking is then manually locked.

The idea underlying the invention shall subsequently be further explained with the help of the exemplary embodiments illustrated in the figures. In the figures:

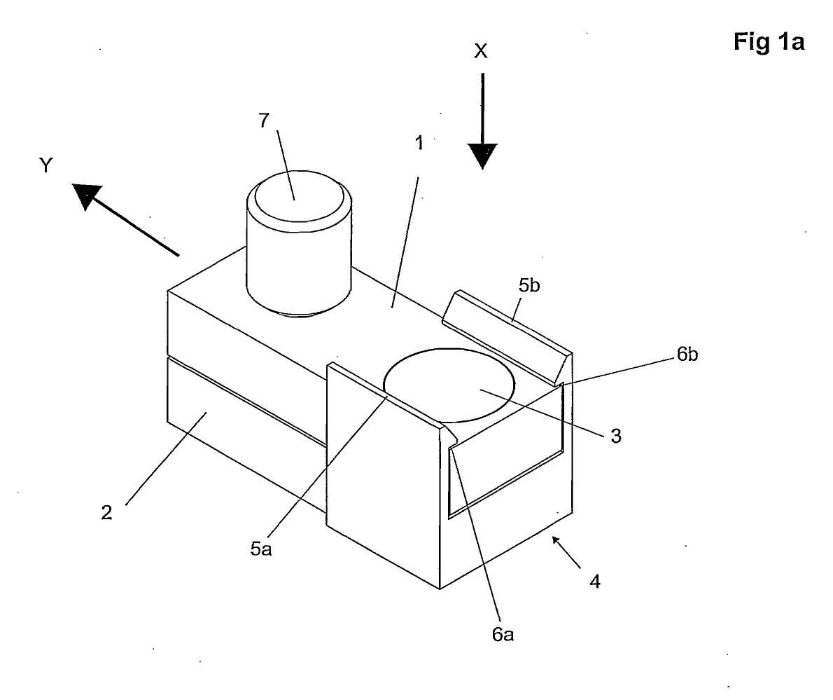

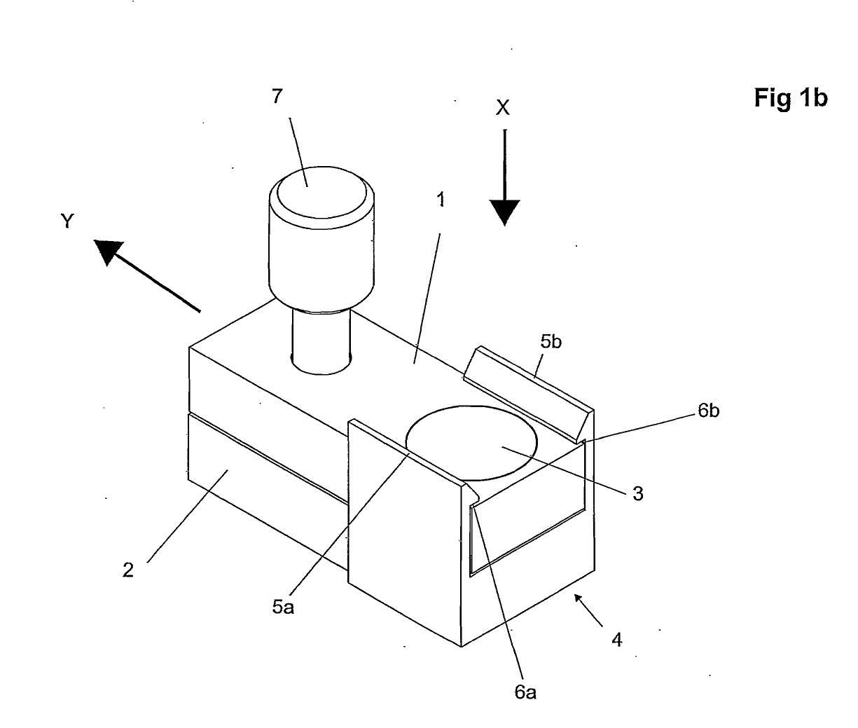

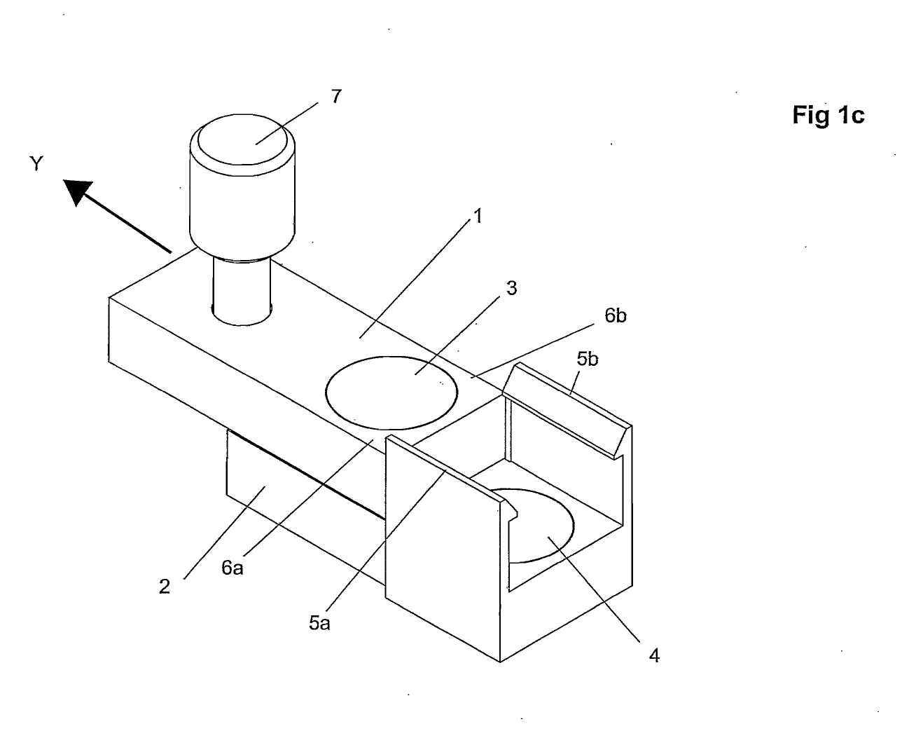

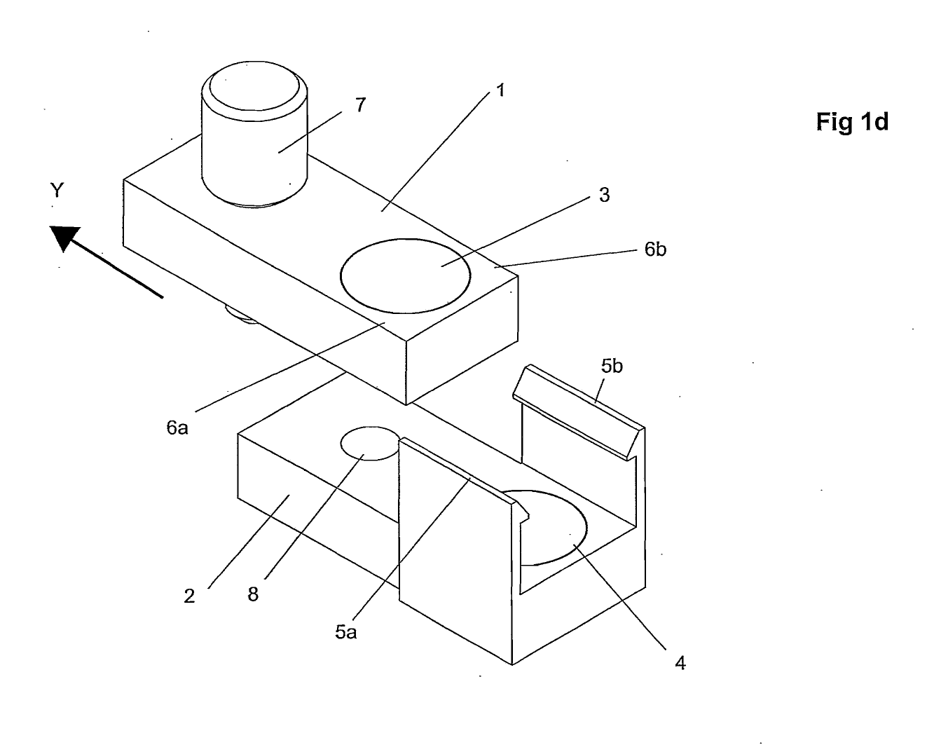

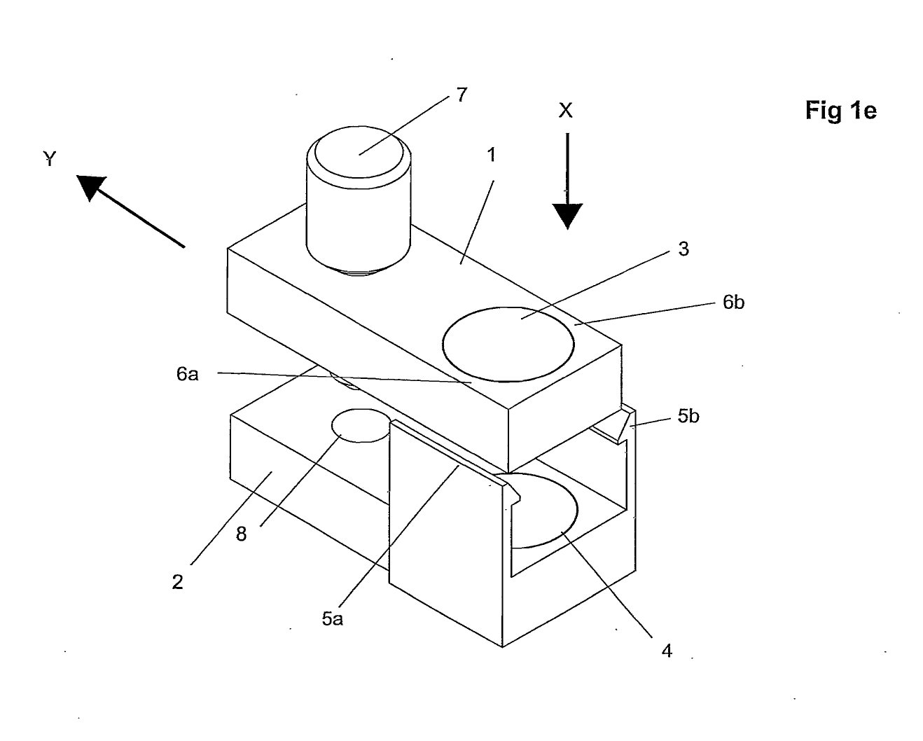

FIGS. 1a-1e show schematic views of a first embodiment of a lock device;

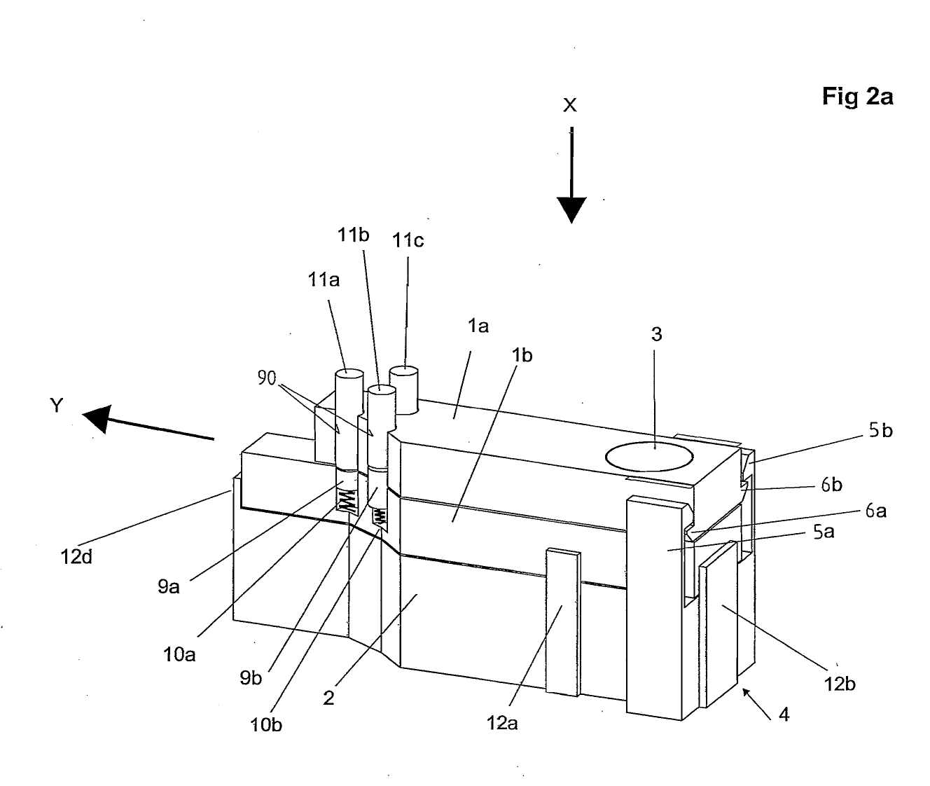

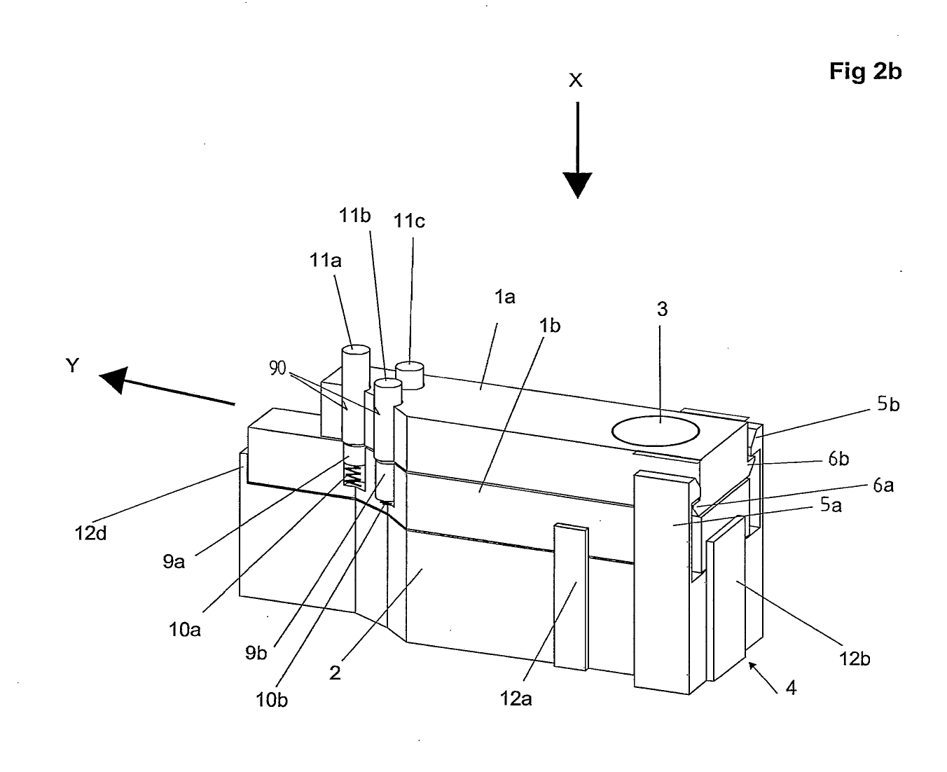

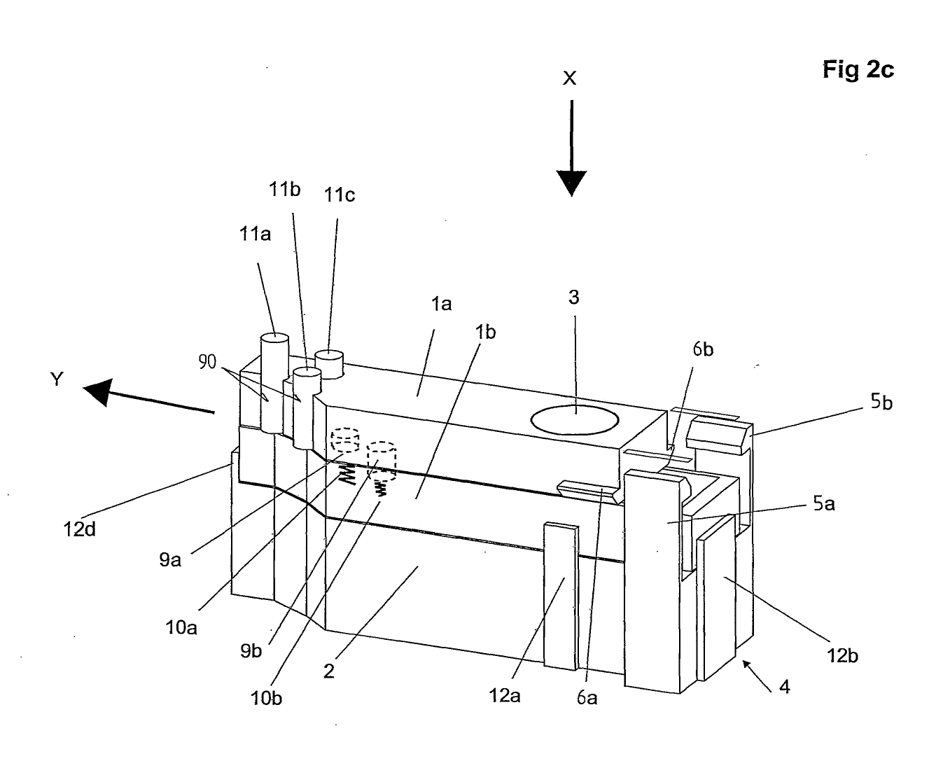

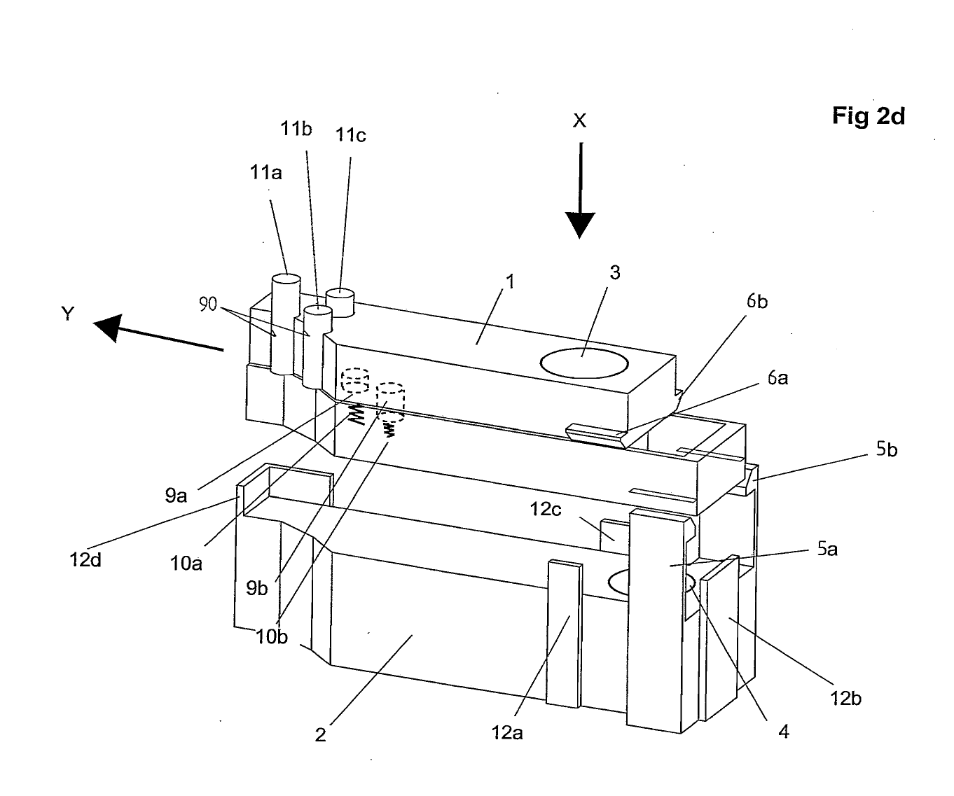

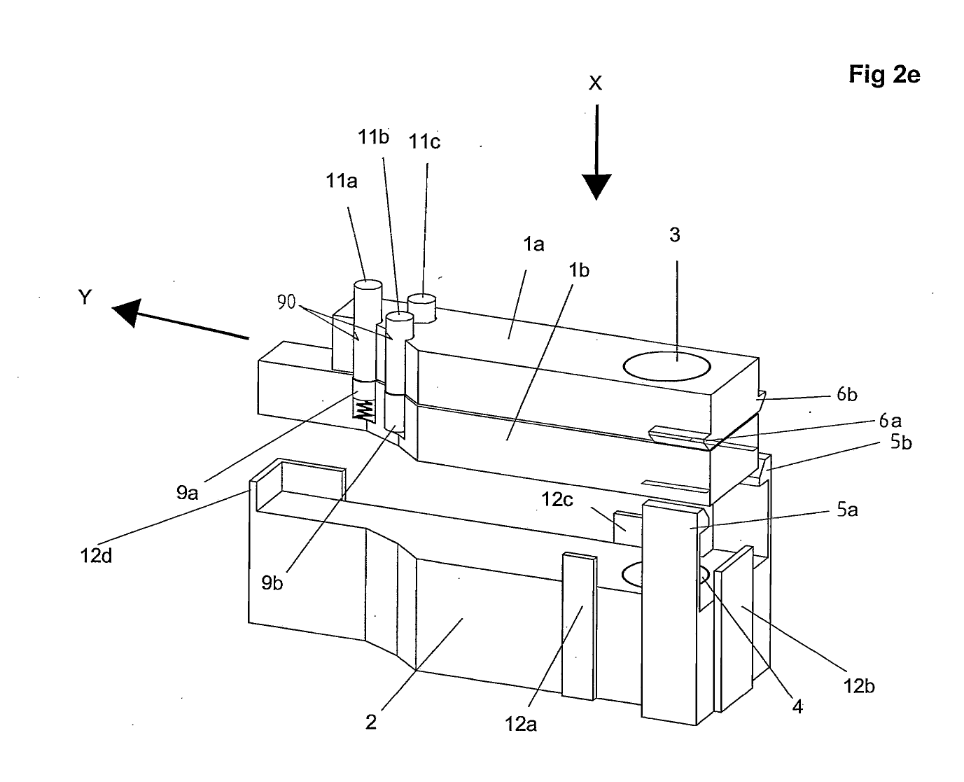

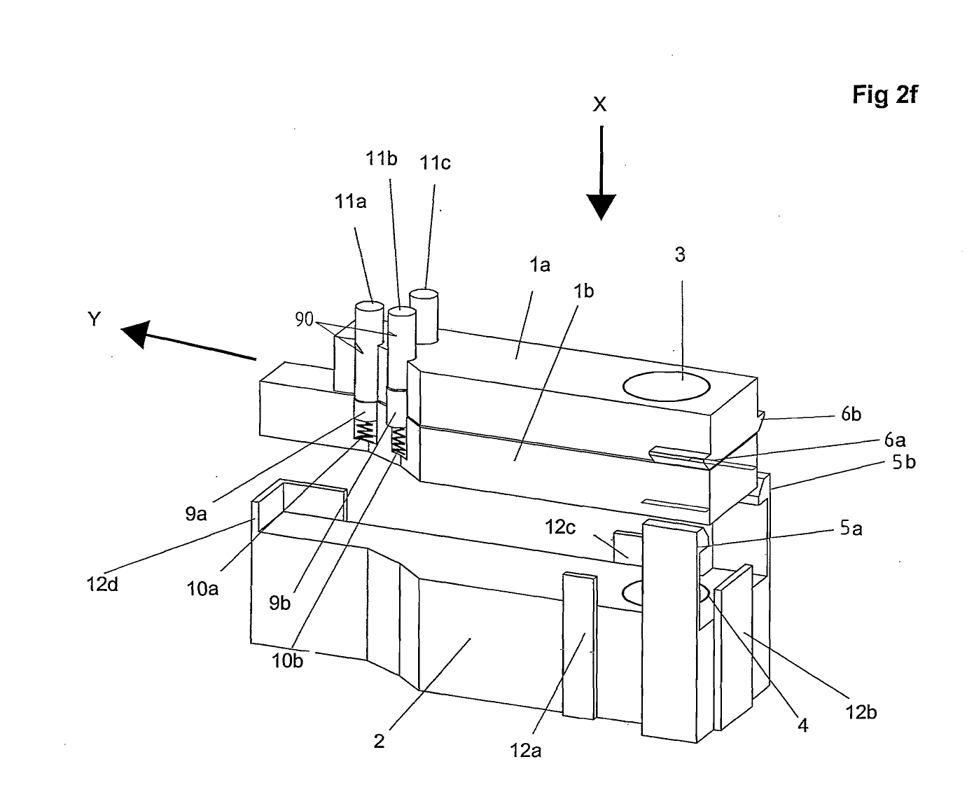

FIGS. 2a-2f show schematic views of a second embodiment of a lock device;

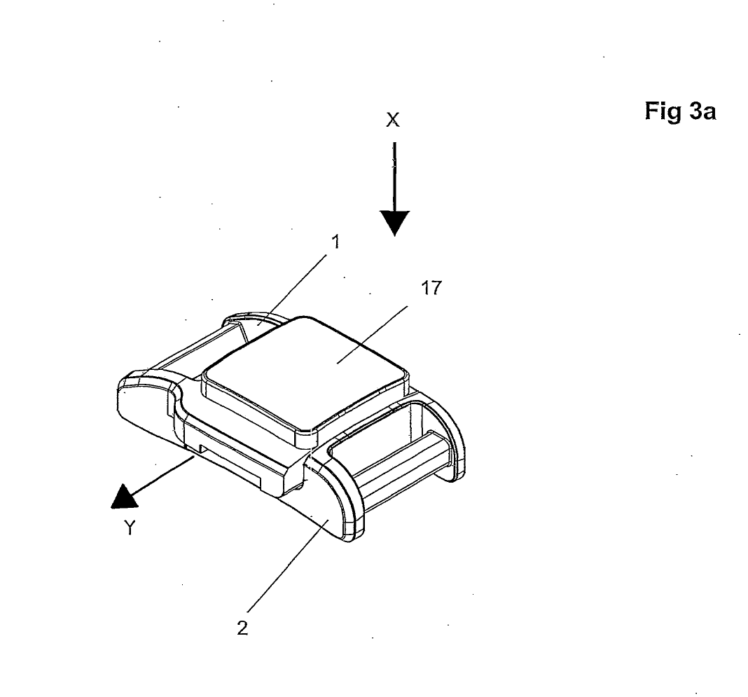

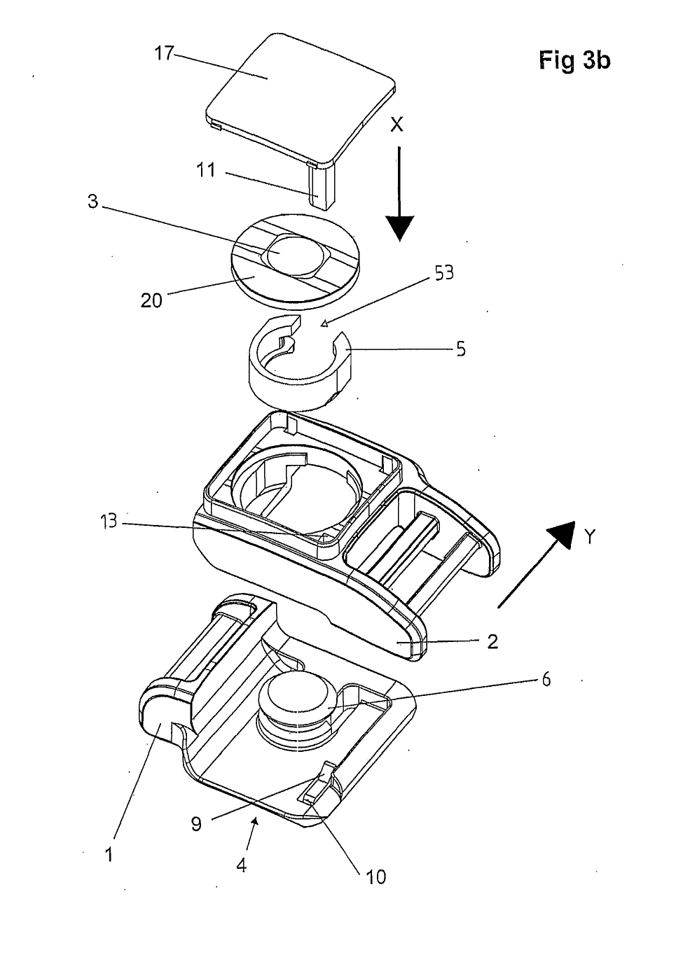

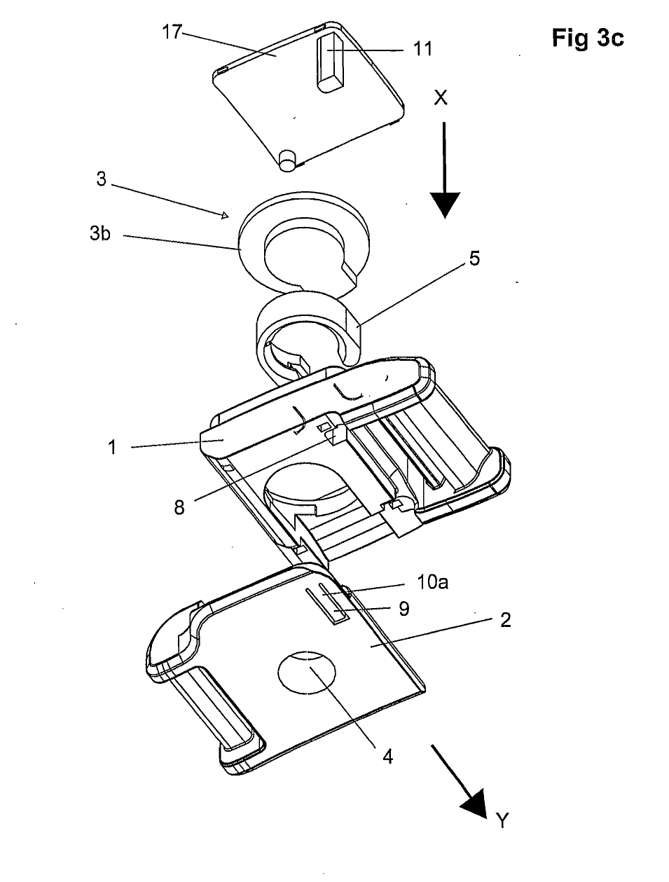

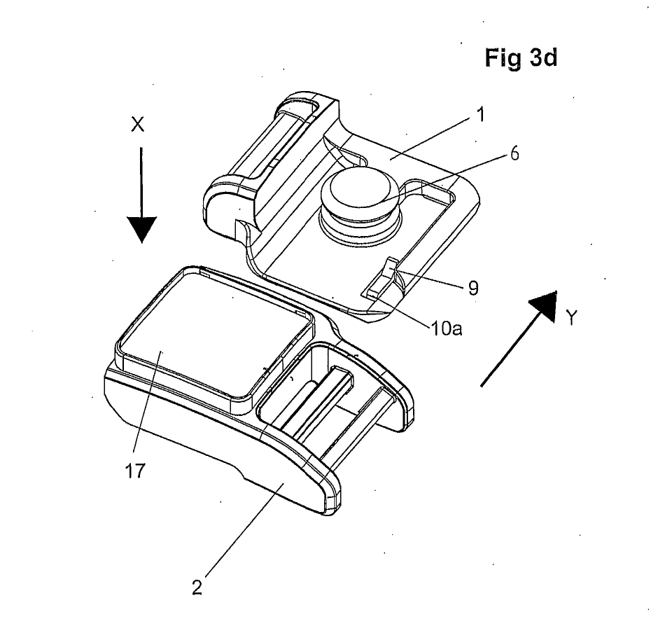

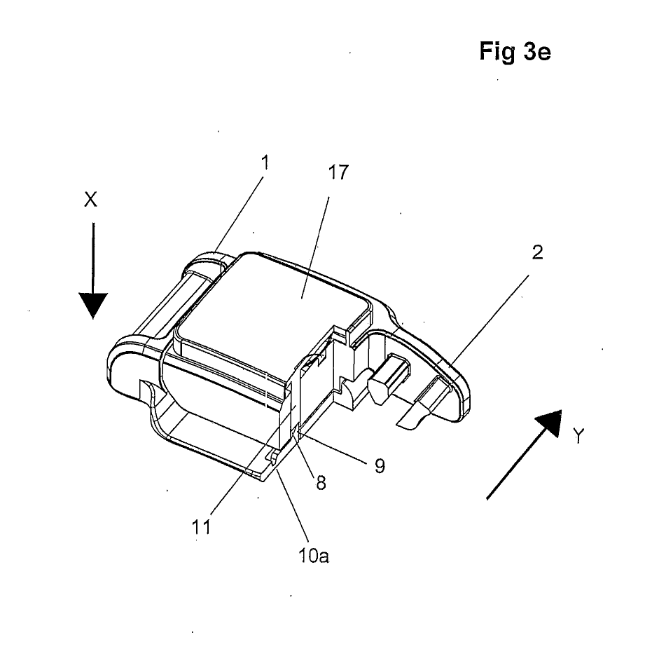

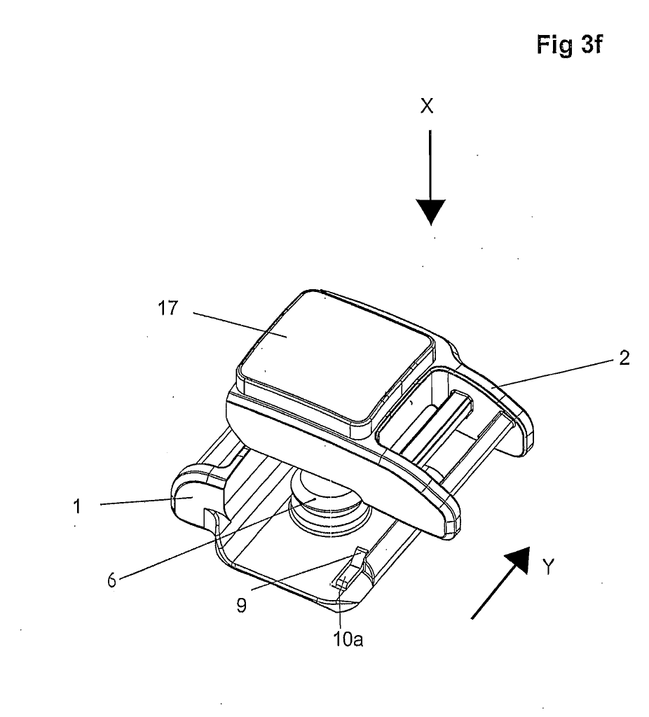

FIG. 3a shows a perspective view of a third embodiment of a lock device;

FIGS. 3b, 3c show perspective exploded views of the lock device according to FIG. 3a;

FIGS. 3d-3f show views of the lock device according to FIG. 3a in the opened state, in the closed state and upon establishing the closing state;

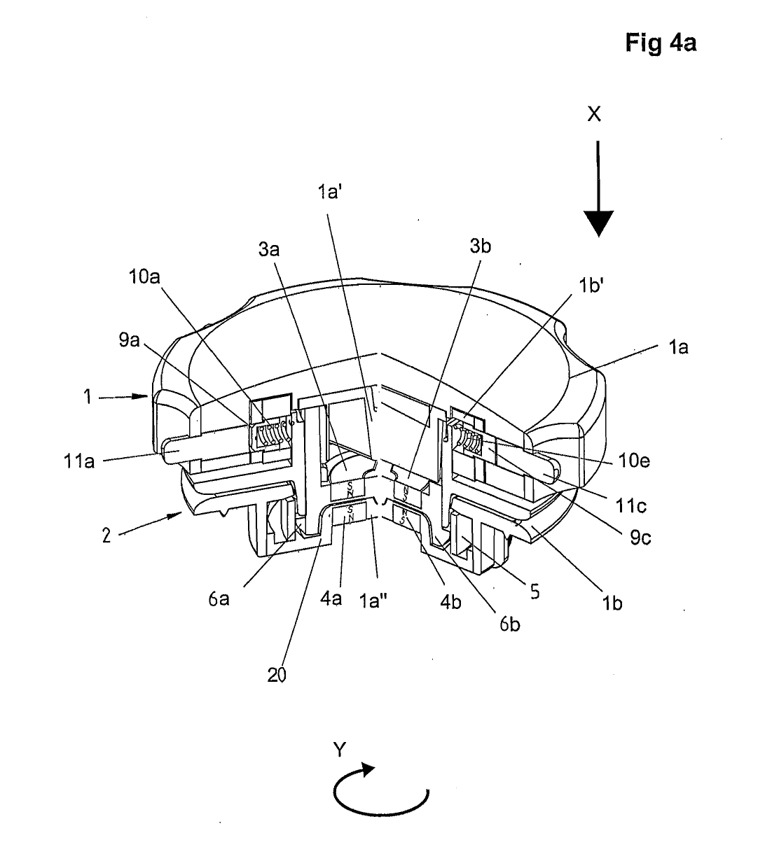

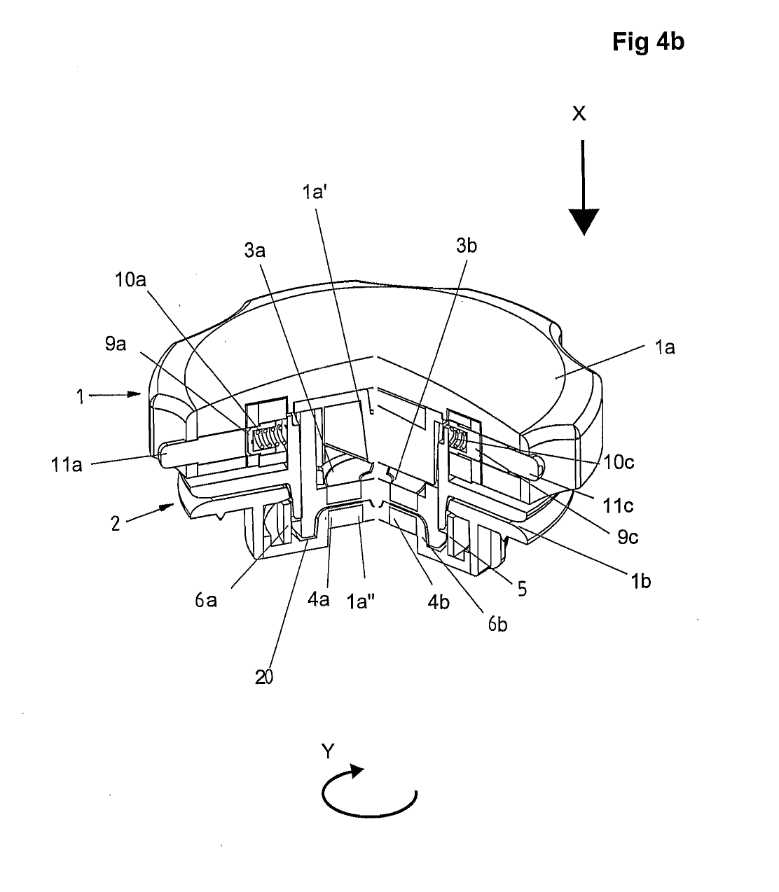

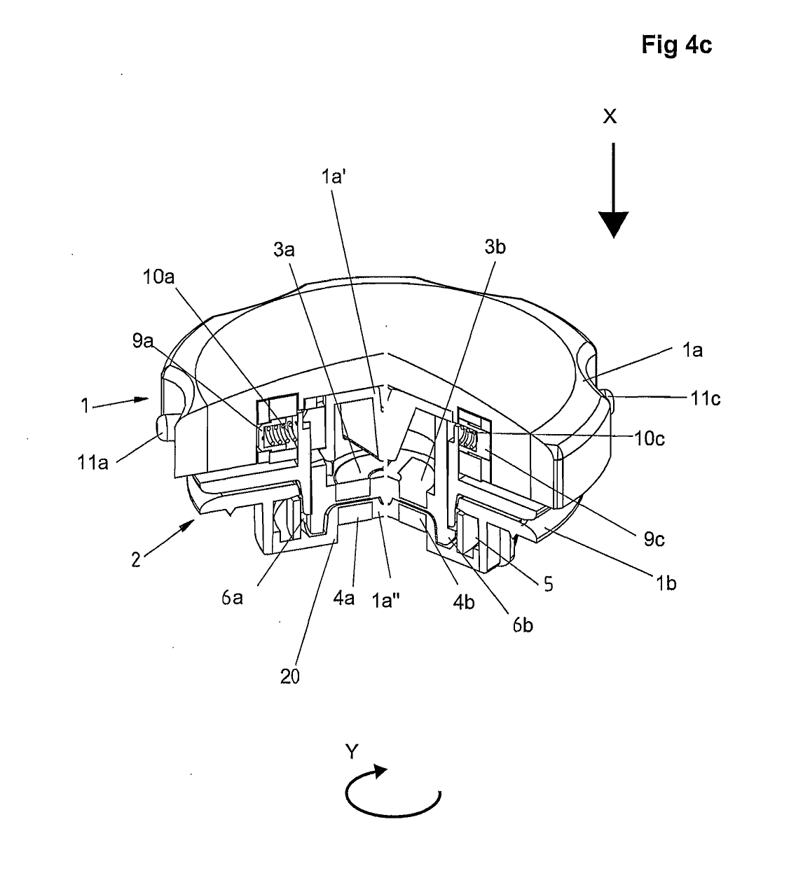

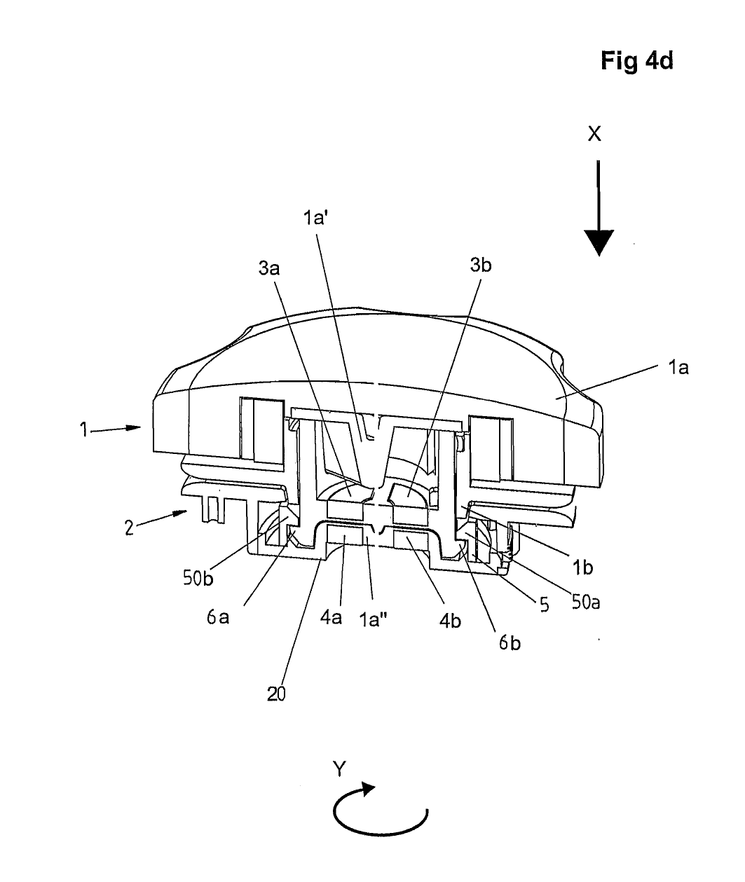

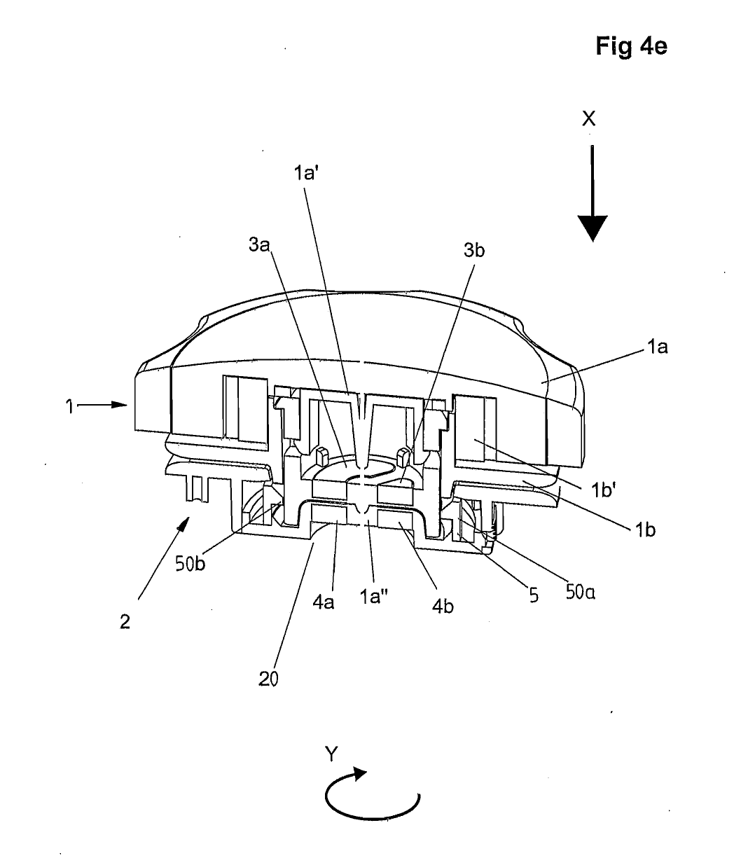

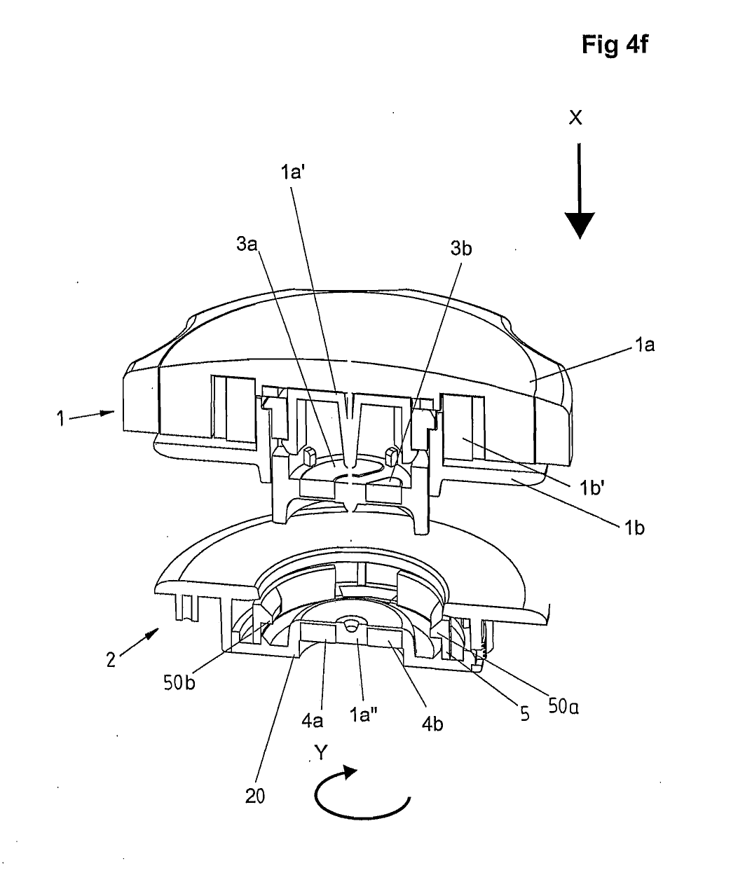

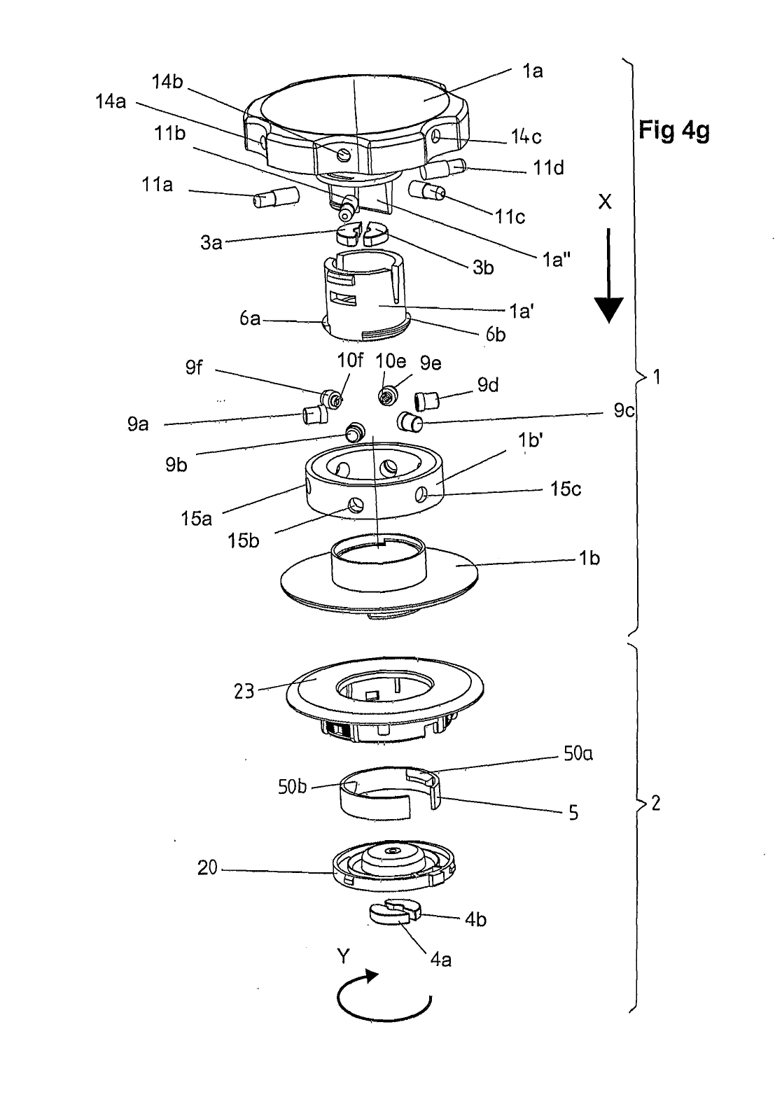

FIGS. 4a-4f show perspective partial views of a fourth embodiment of a lock device;

FIG. 4g shows a perspective exploded view of the lock device according to FIGS. 4a-4f;

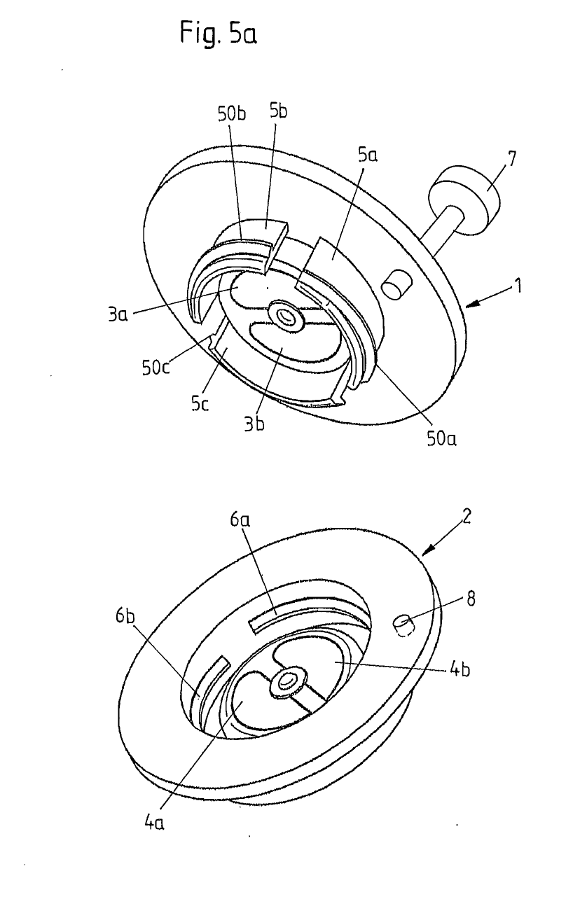

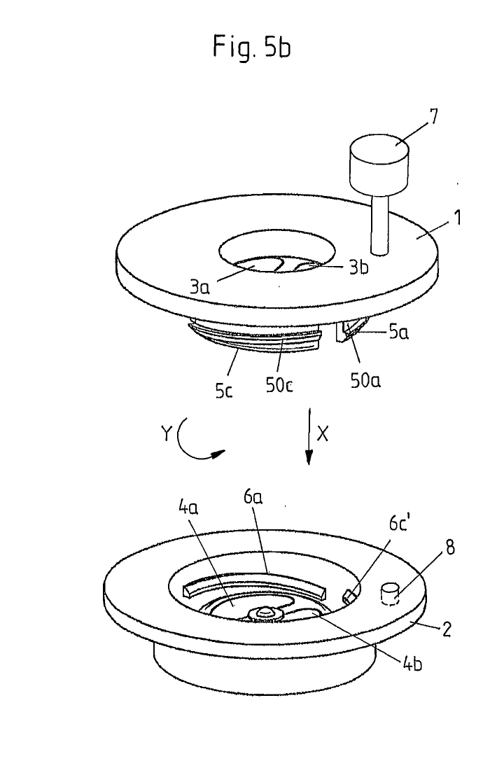

FIGS. 5a, 5b show views of a fifth embodiment of a lock device;

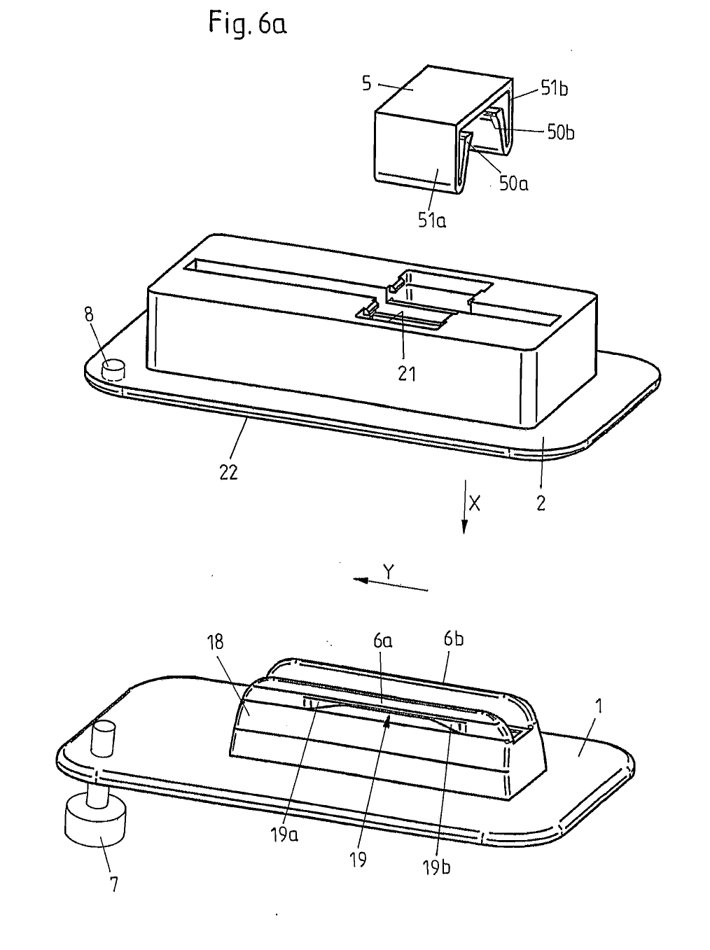

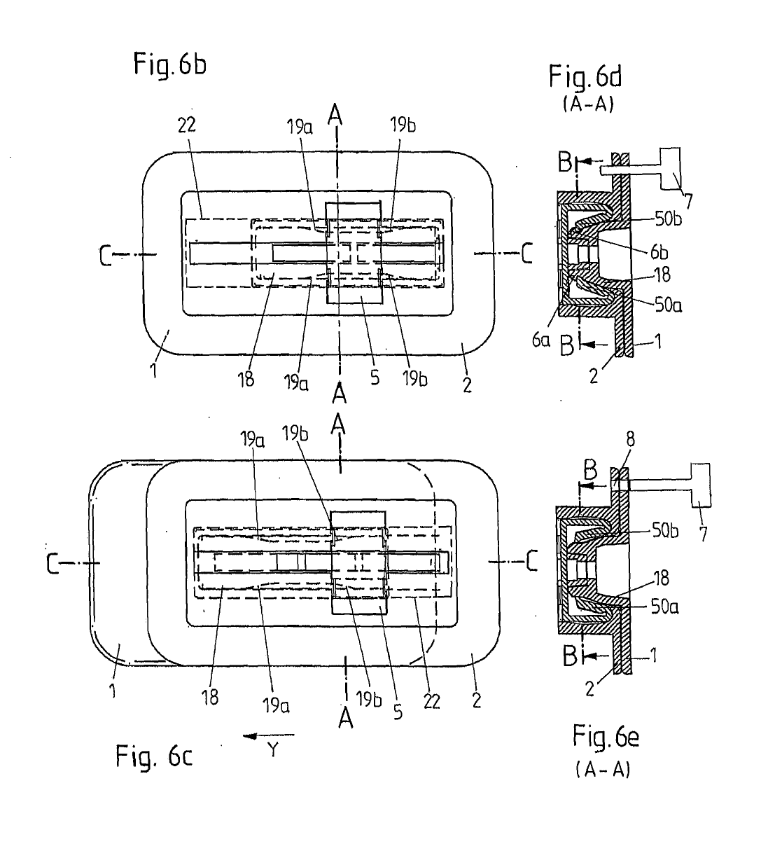

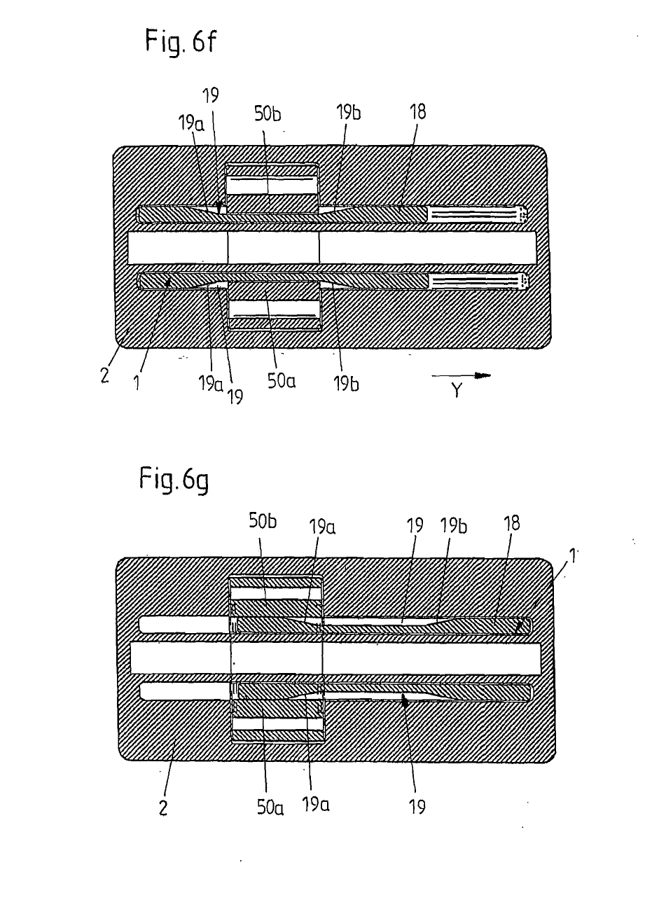

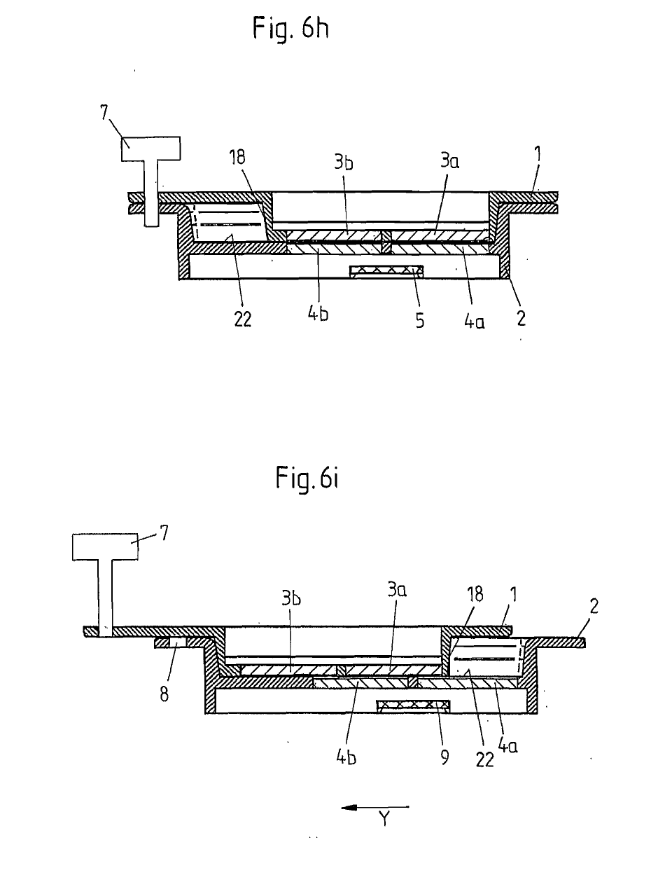

FIGS. 6a-6i show views of a sixth embodiment of a lock device;

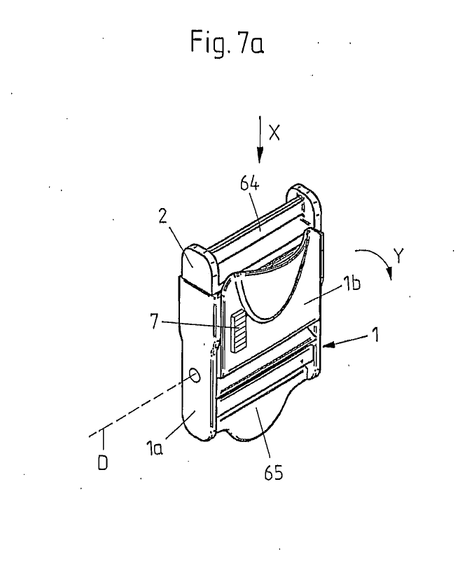

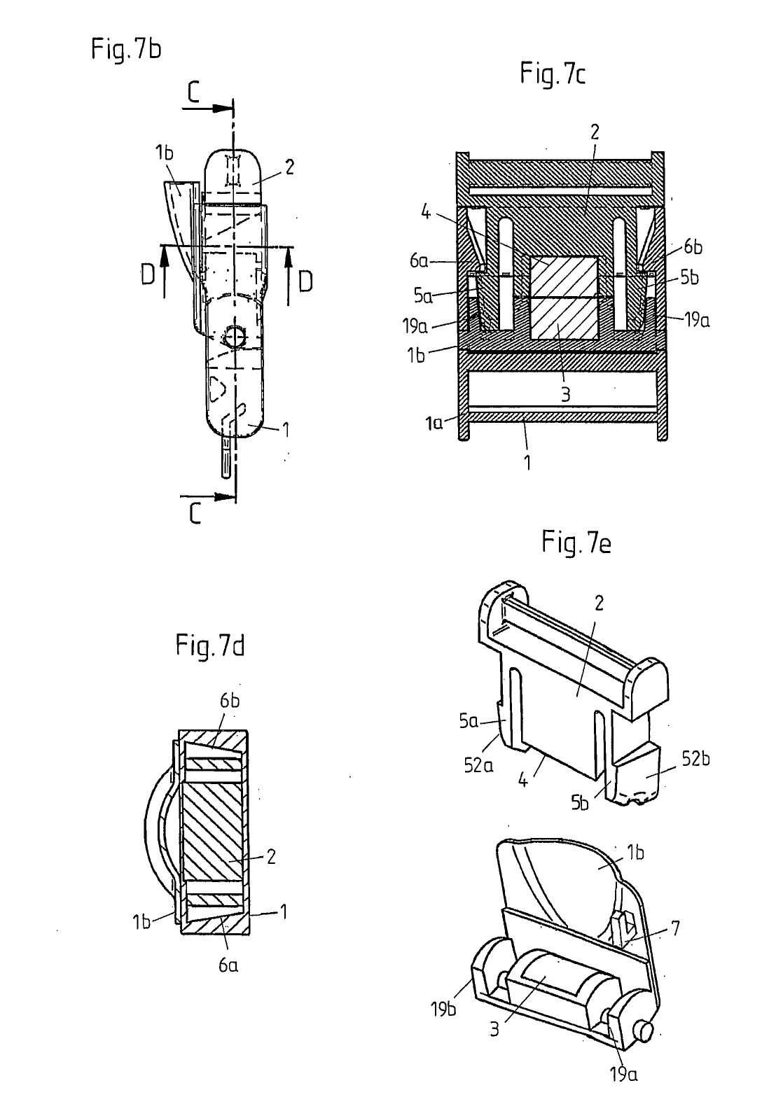

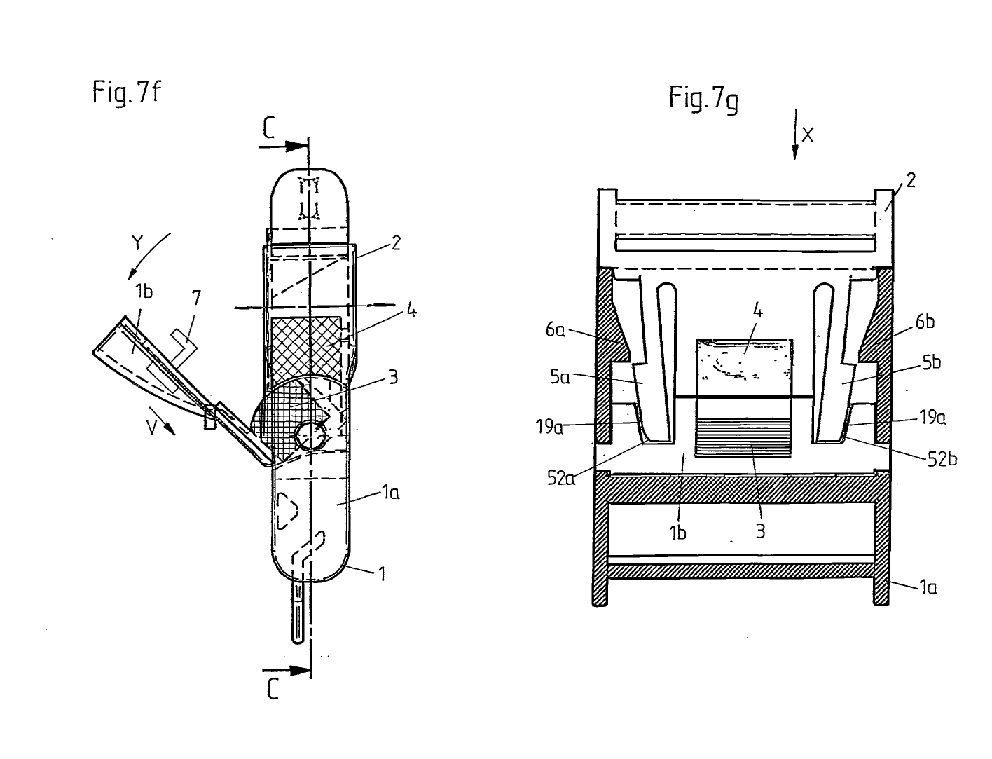

FIGS. 7a-7g show views of a seventh embodiment of a lock device;

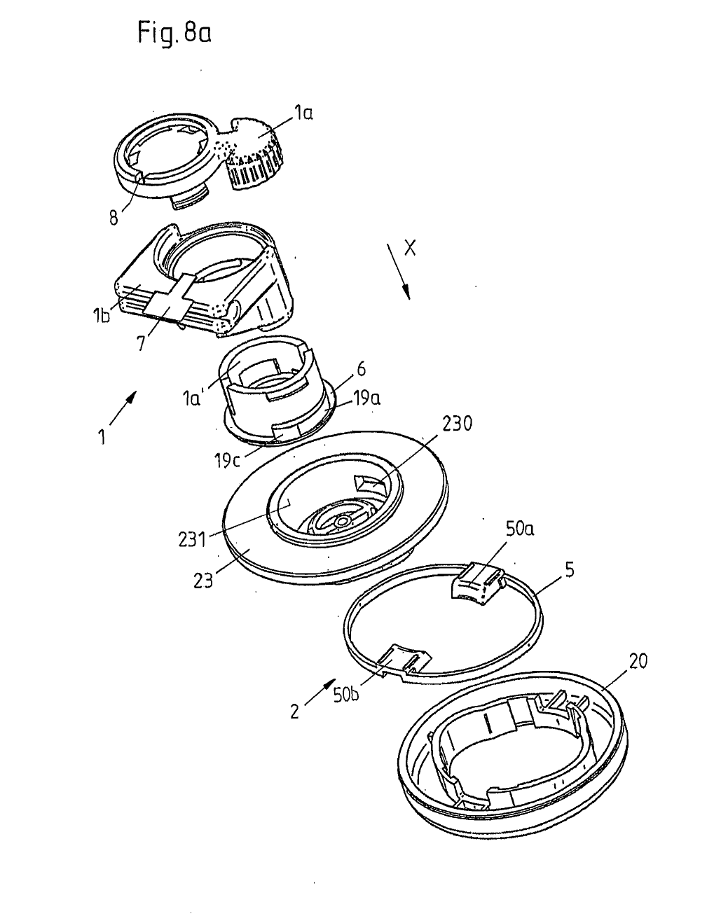

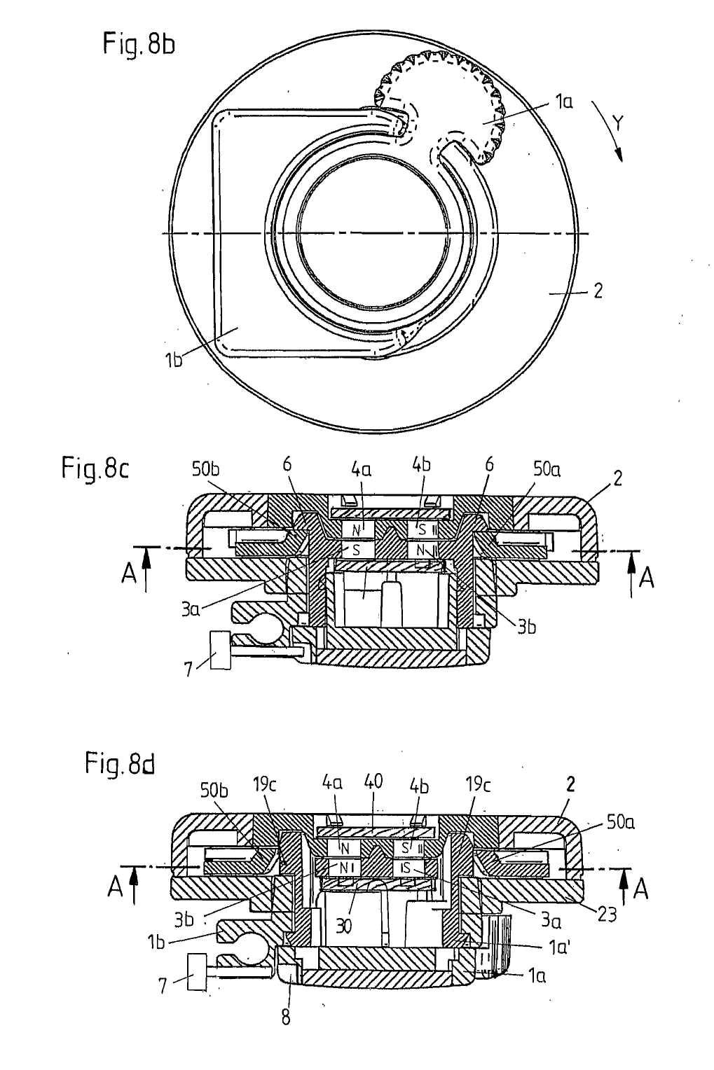

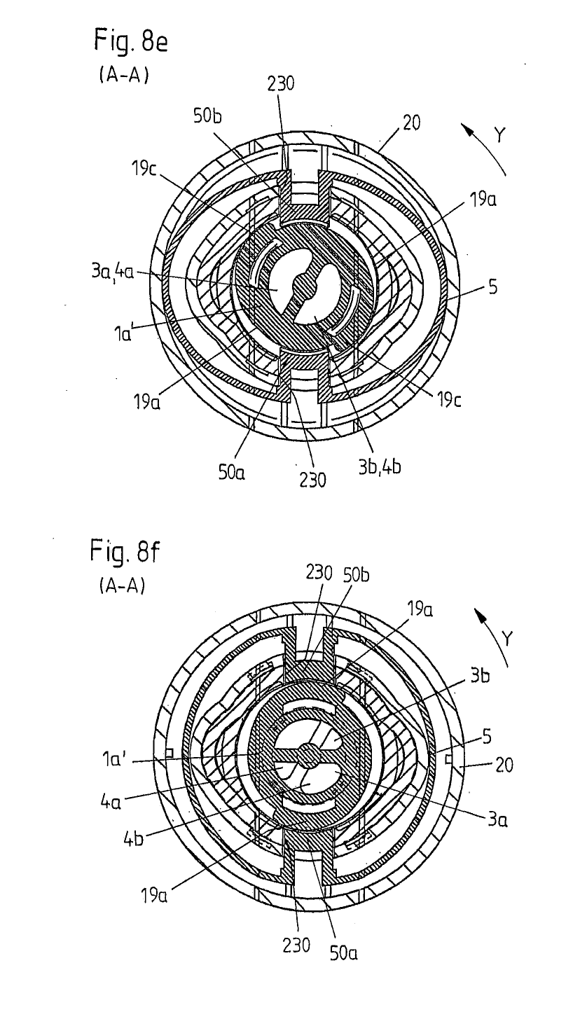

FIGS. 8a-8f show views of an eighth embodiment of a lock device;

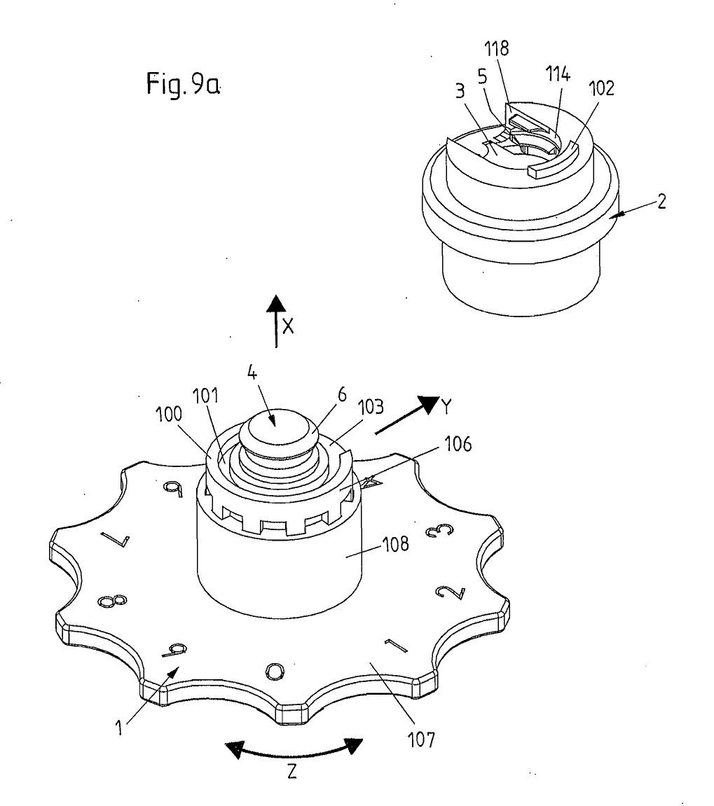

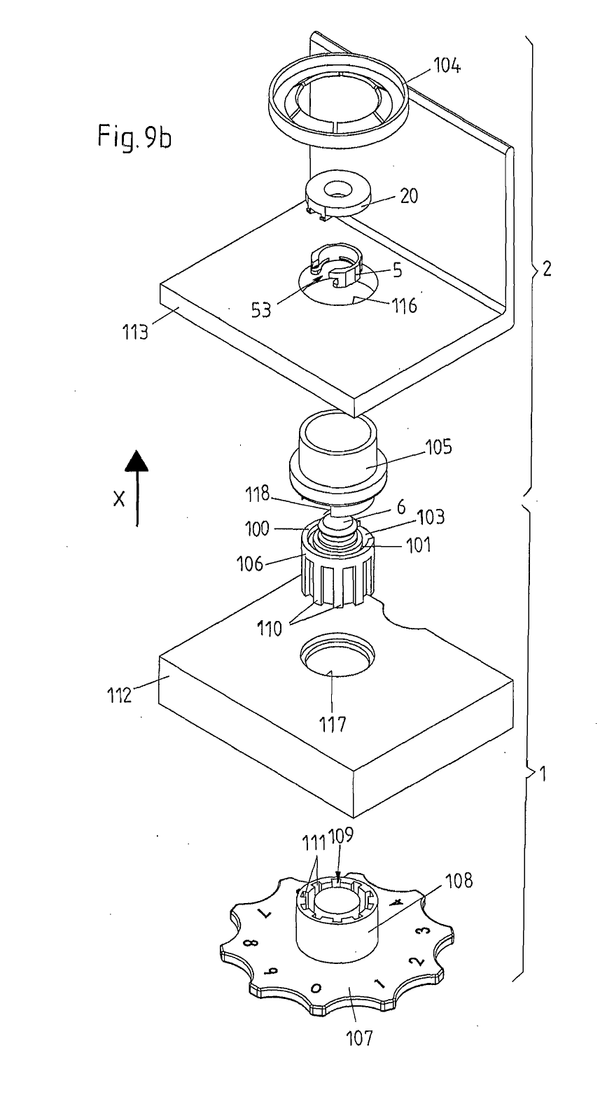

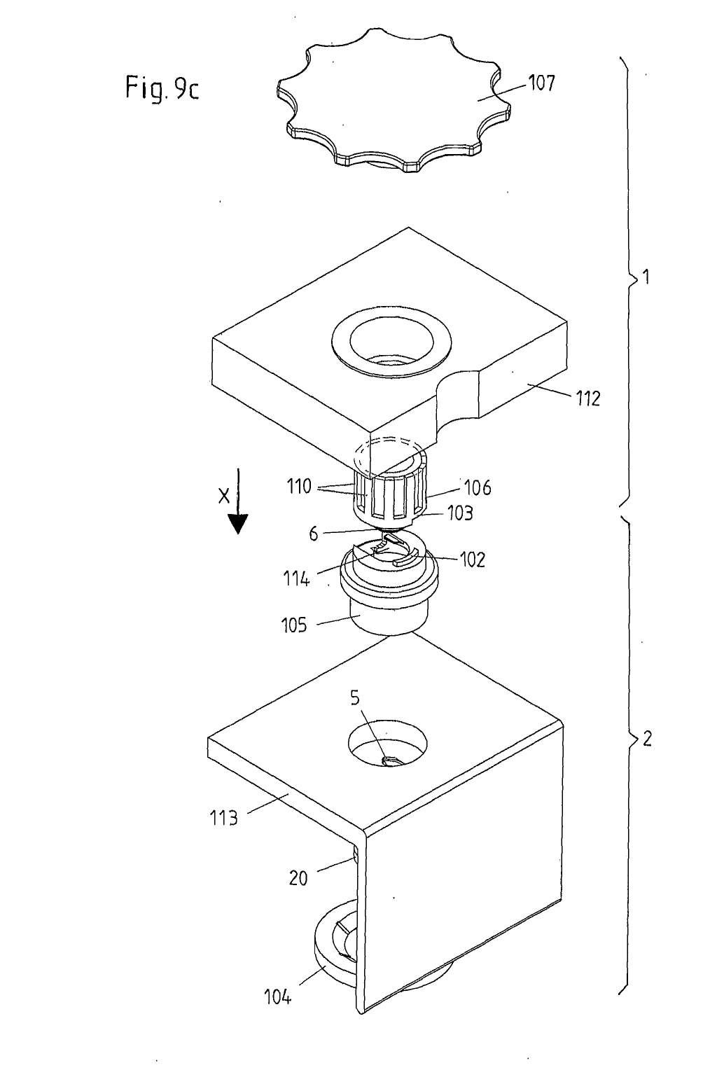

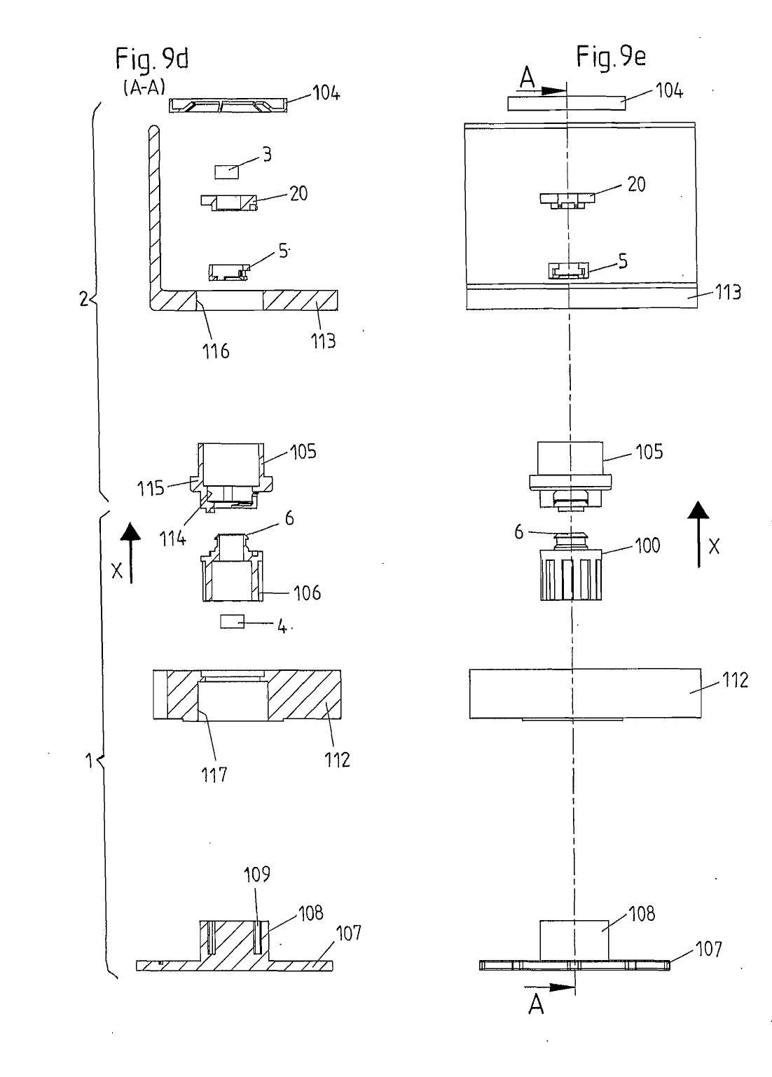

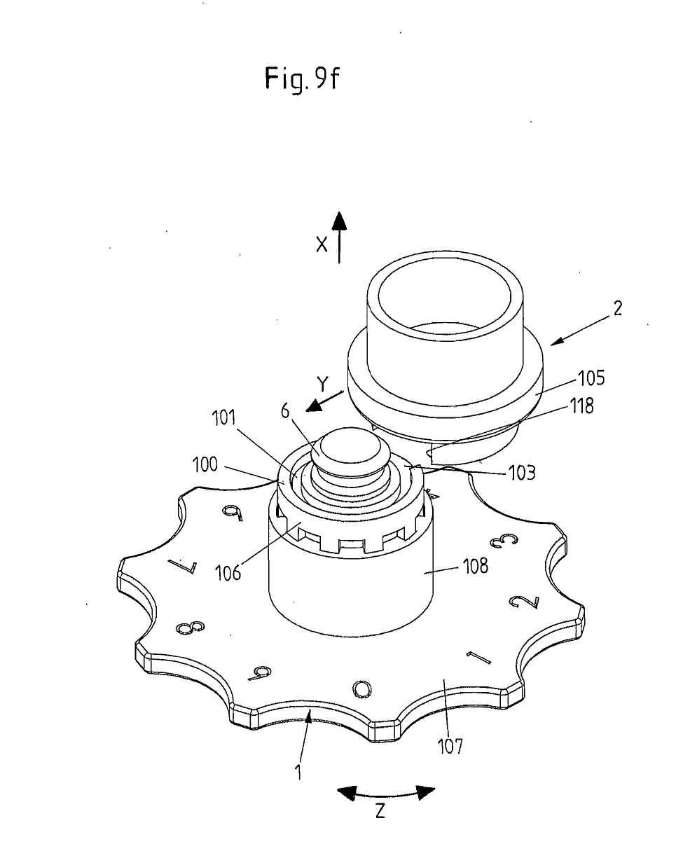

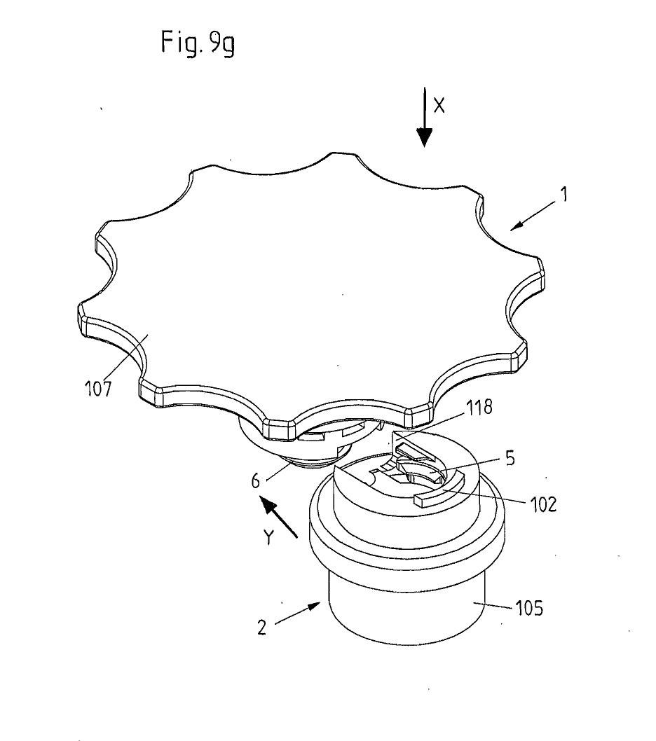

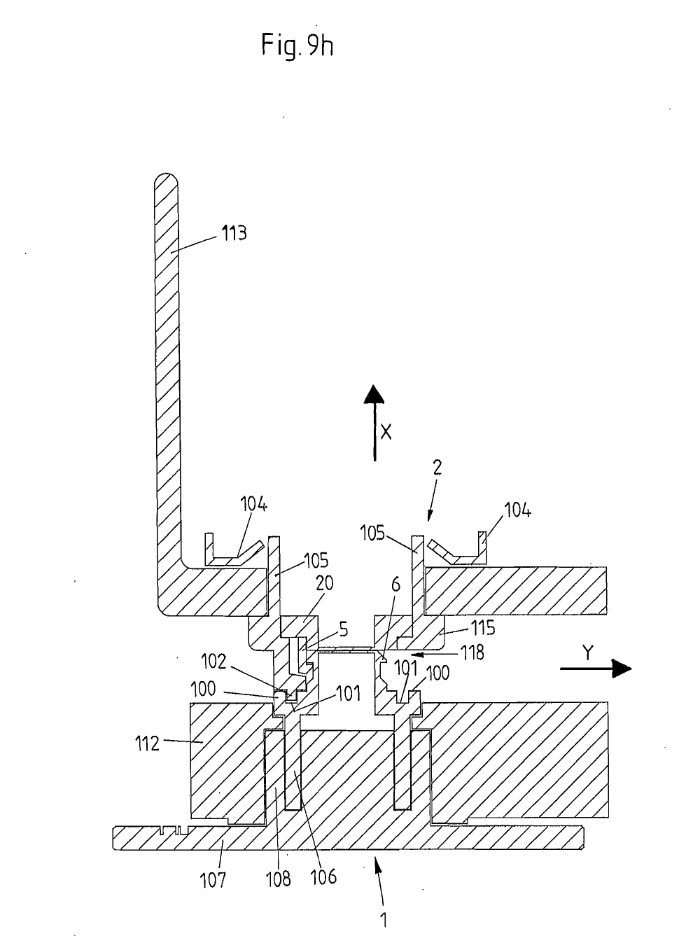

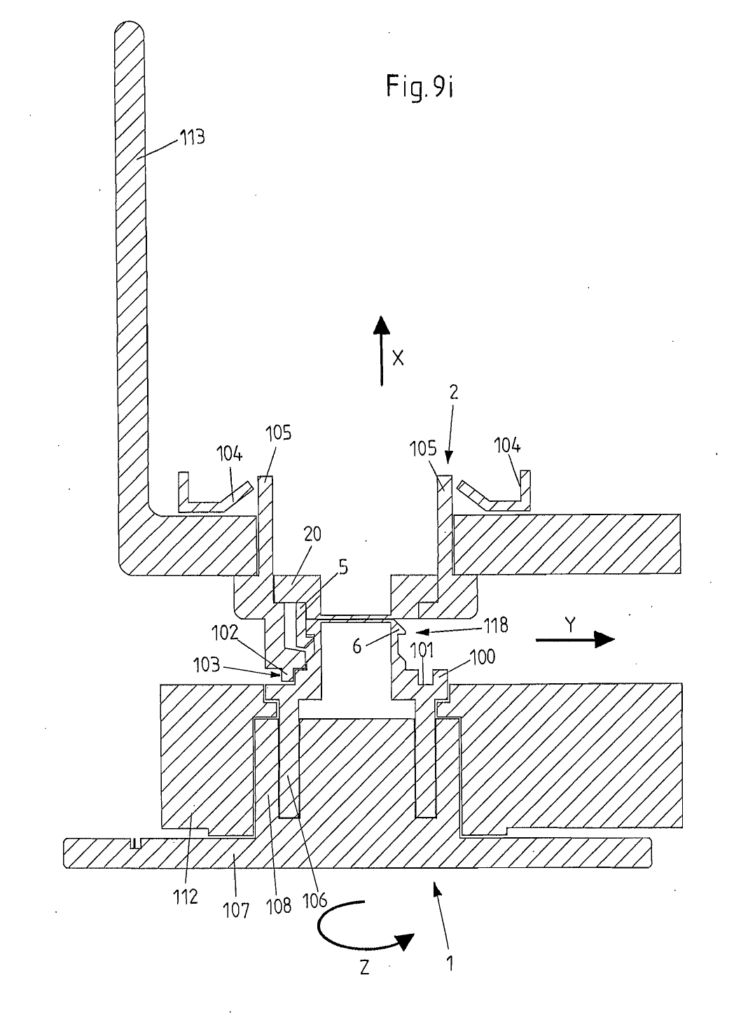

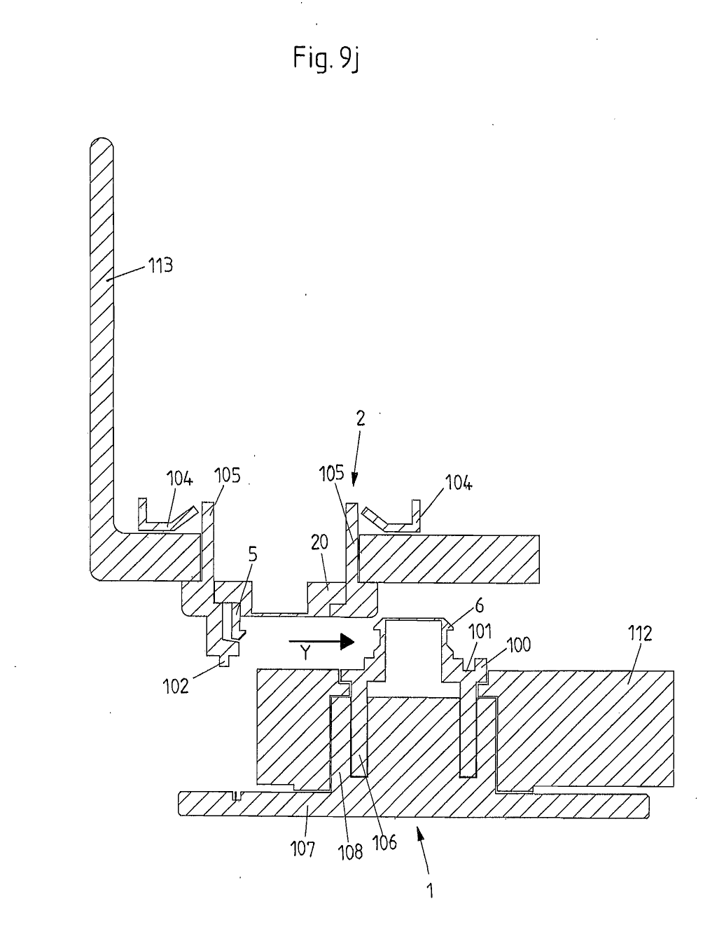

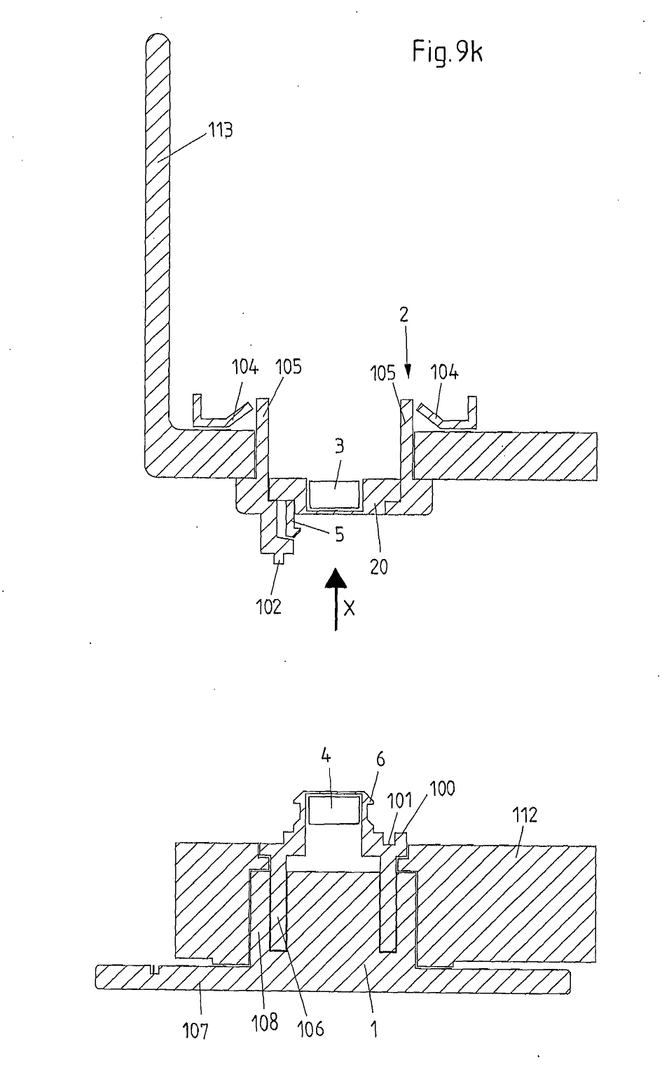

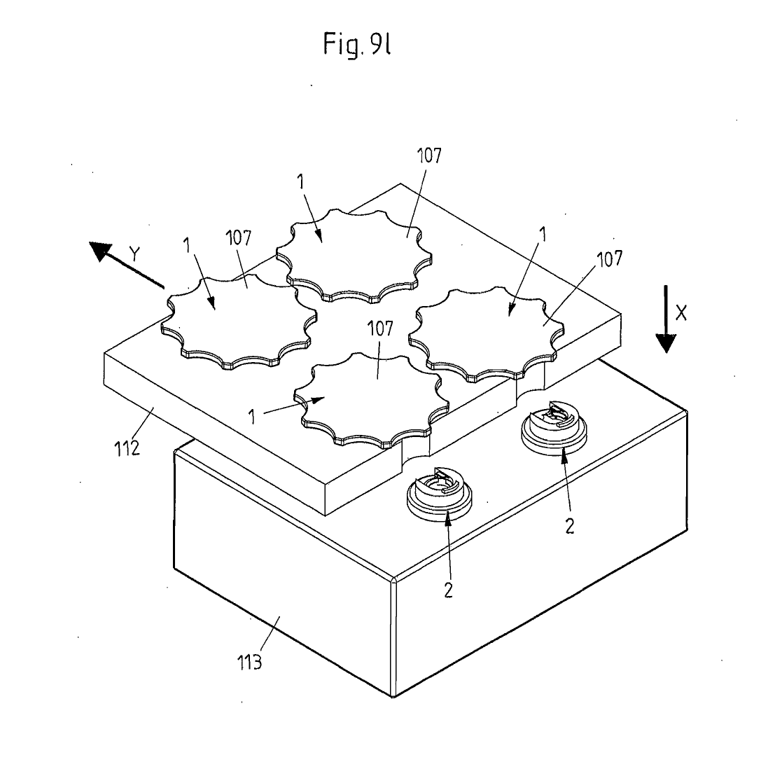

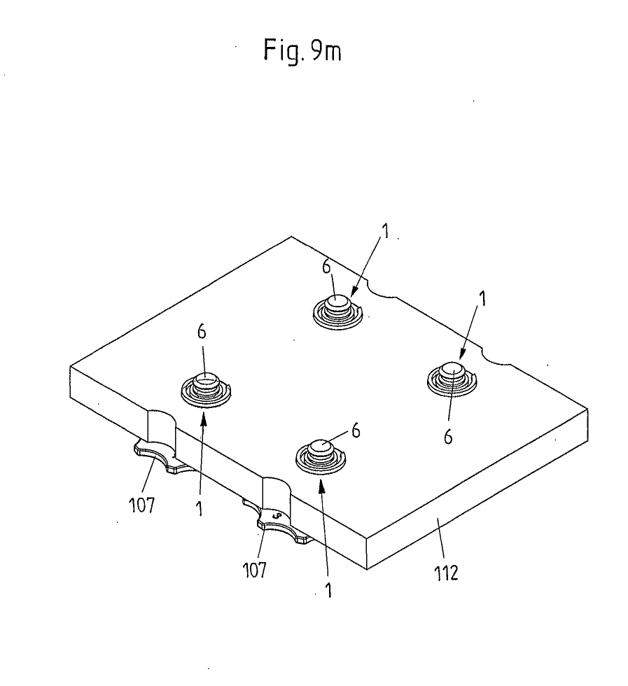

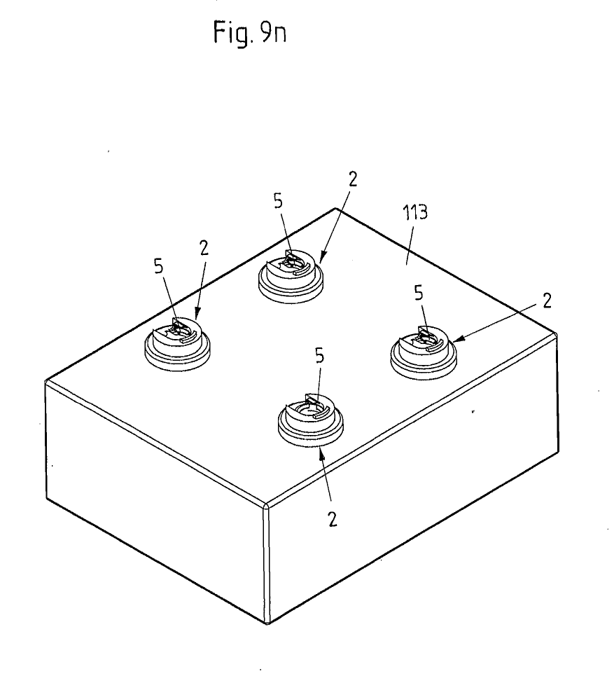

FIGS. 9a-9n show views of a further embodiment of a lock device;

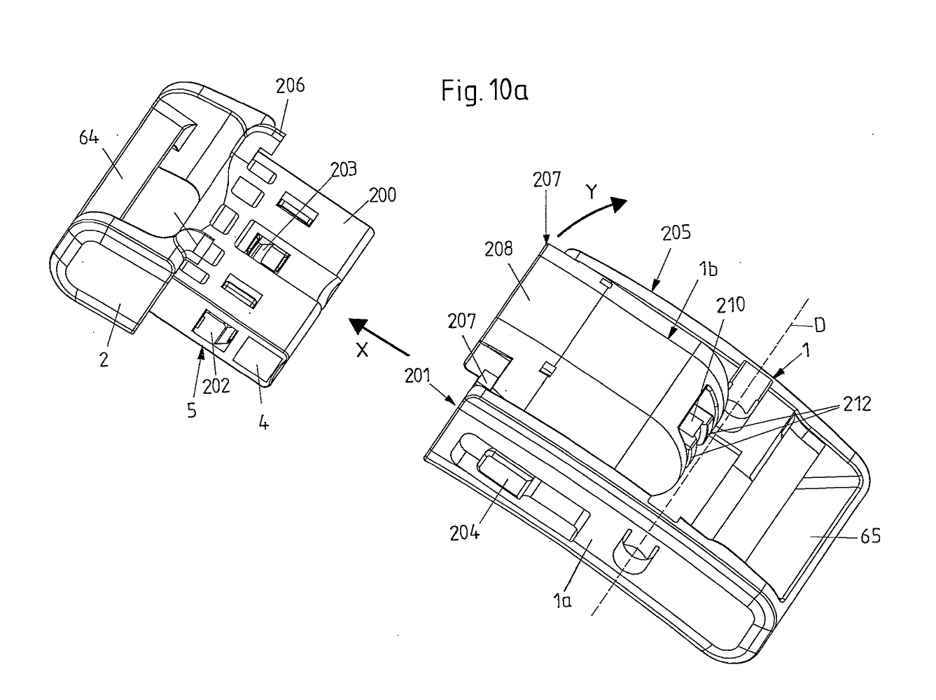

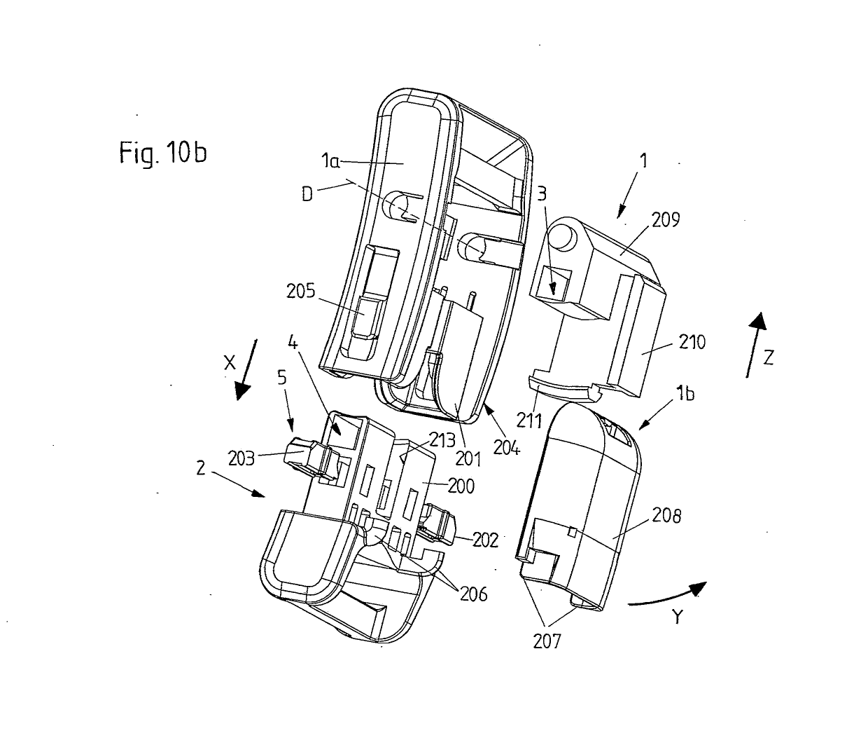

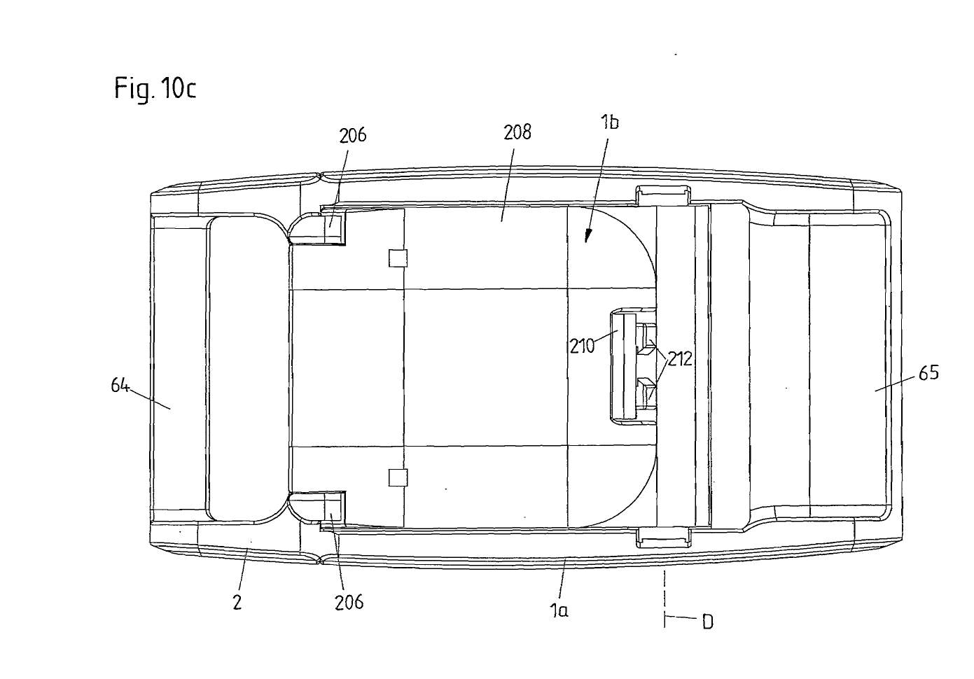

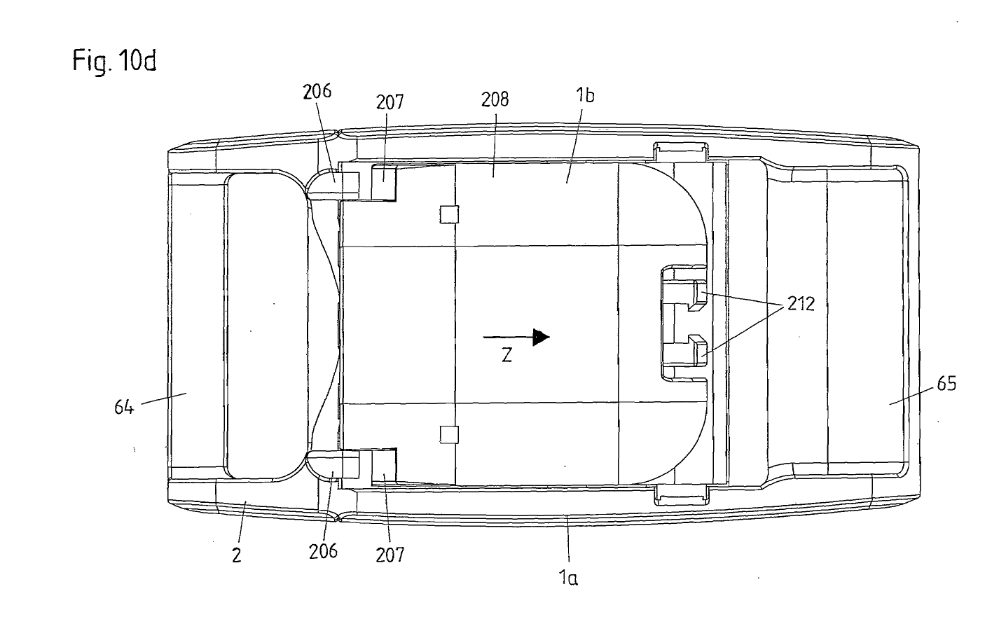

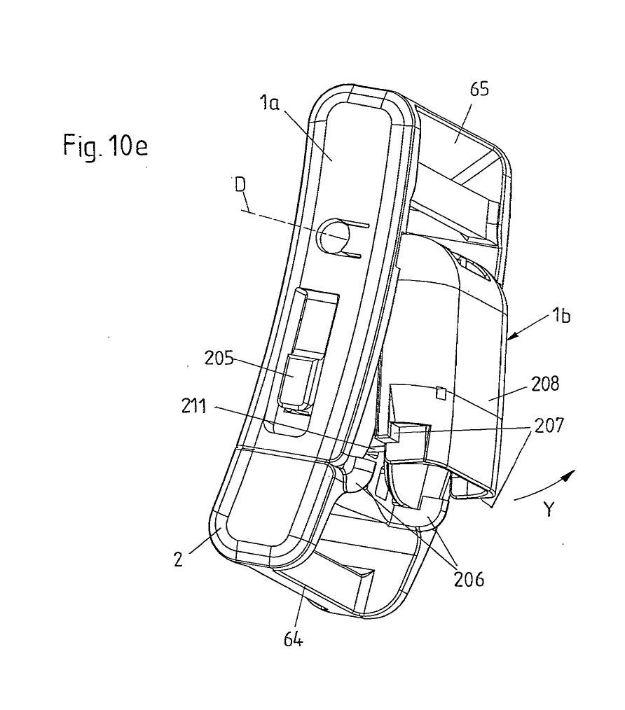

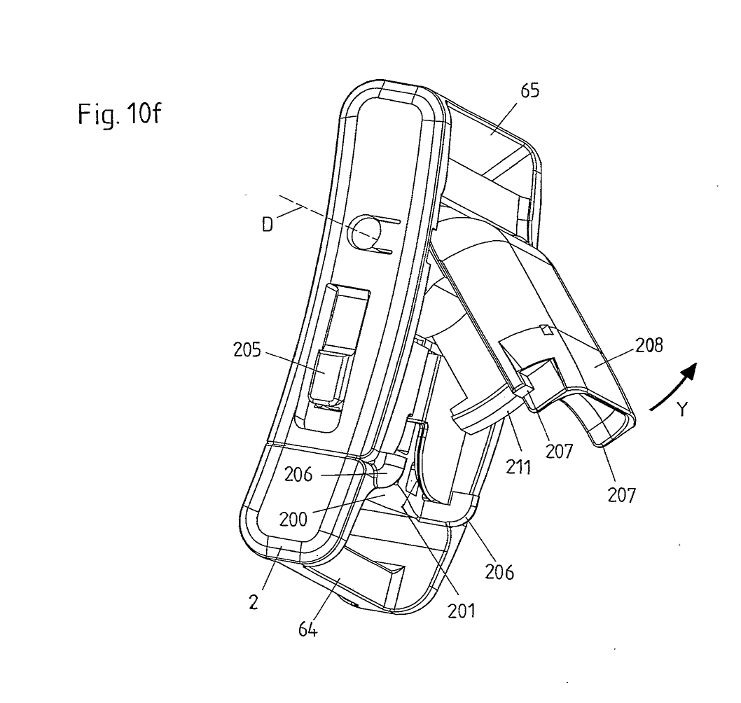

FIGS. 10a-10f show views of yet another further embodiment of a lock device as a kind of clip buckle having a pivotable actuating lever and

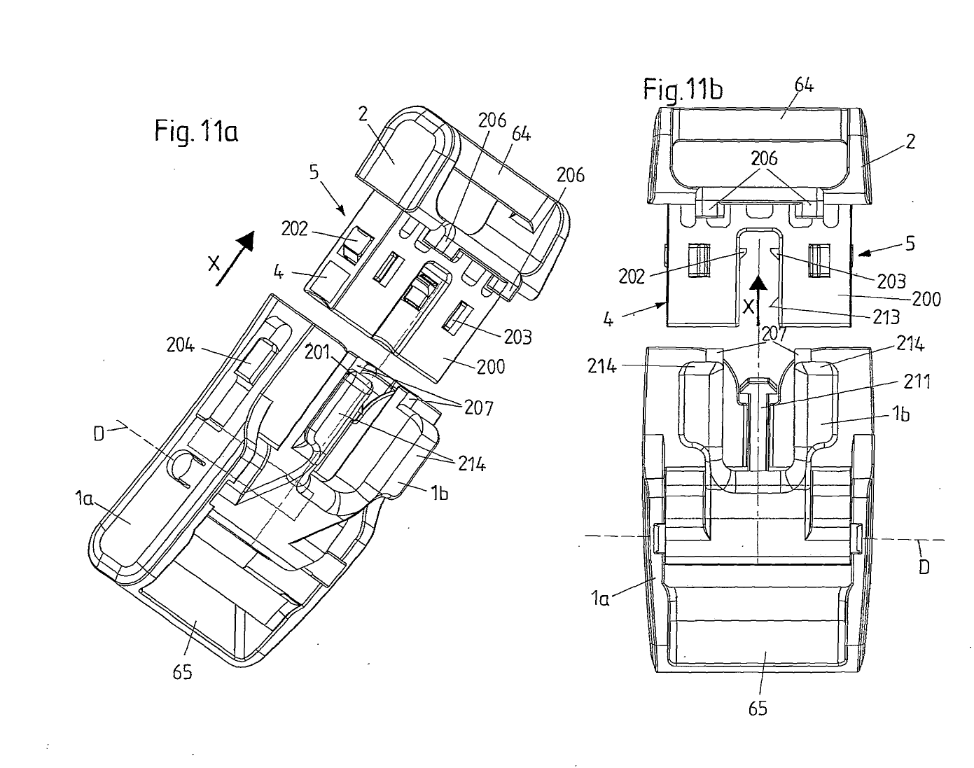

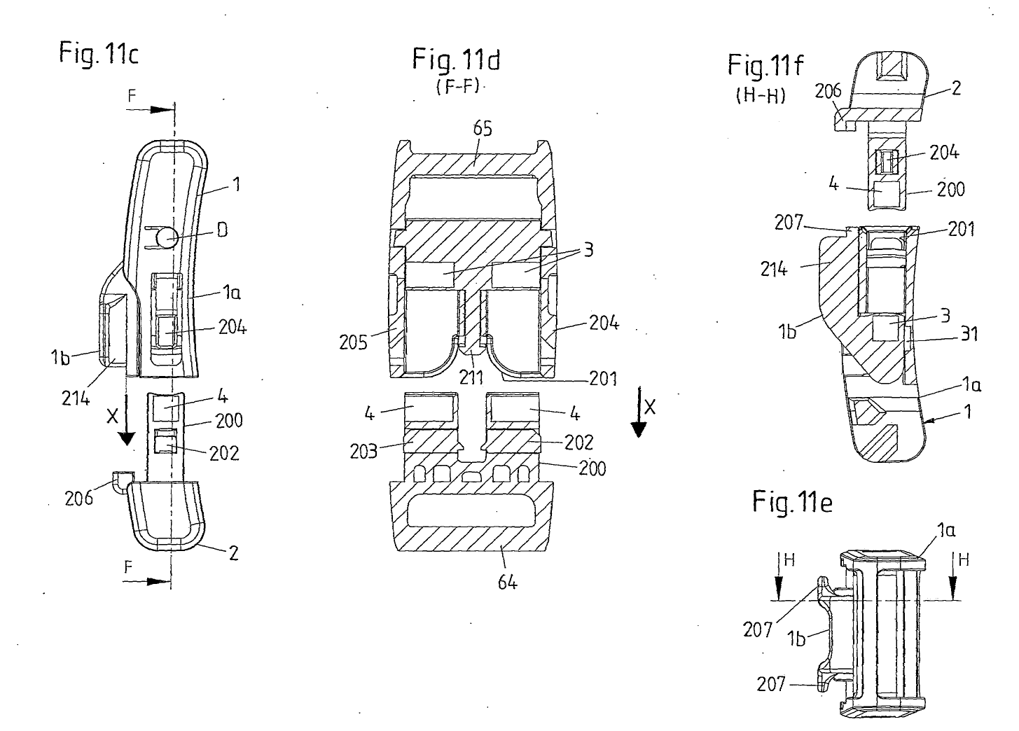

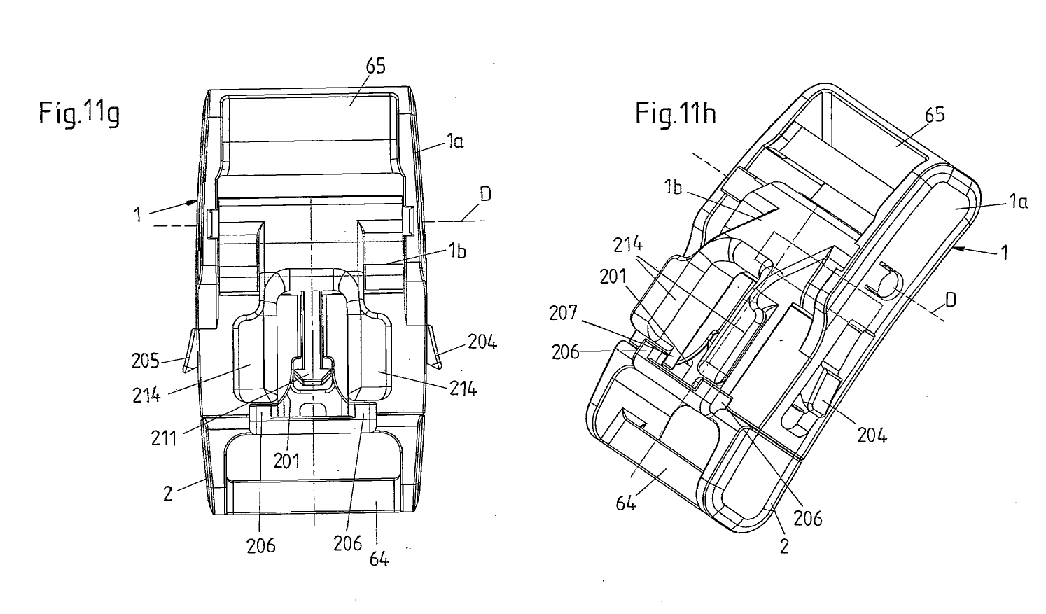

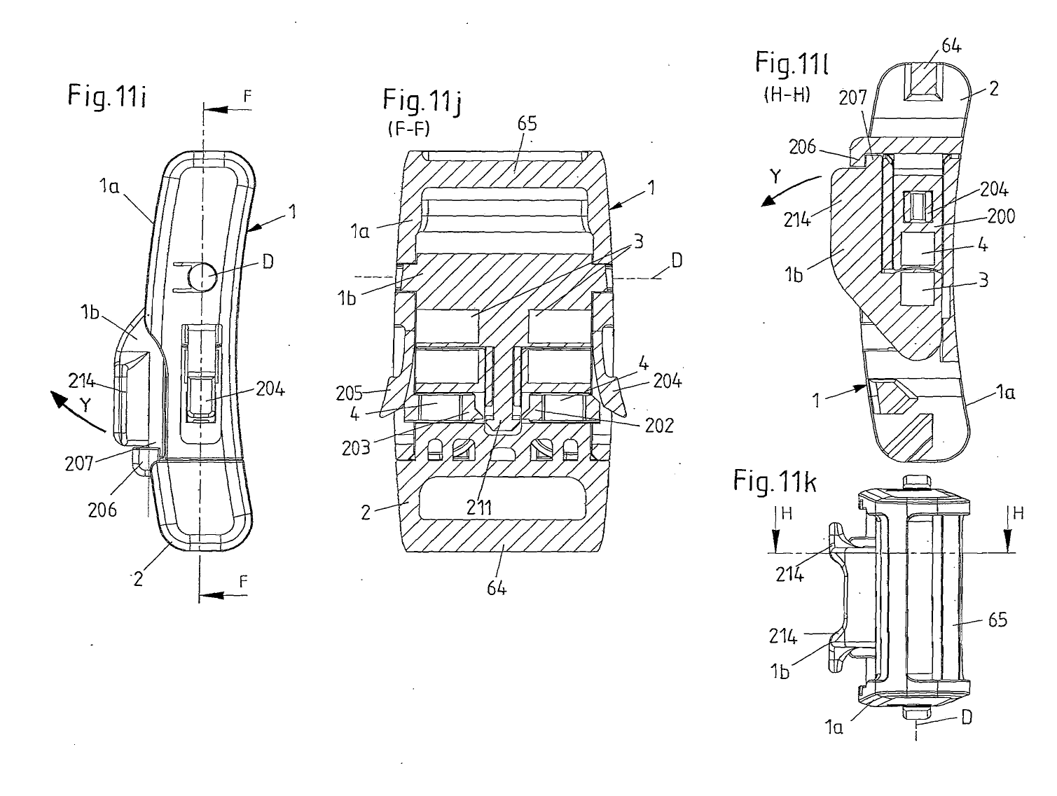

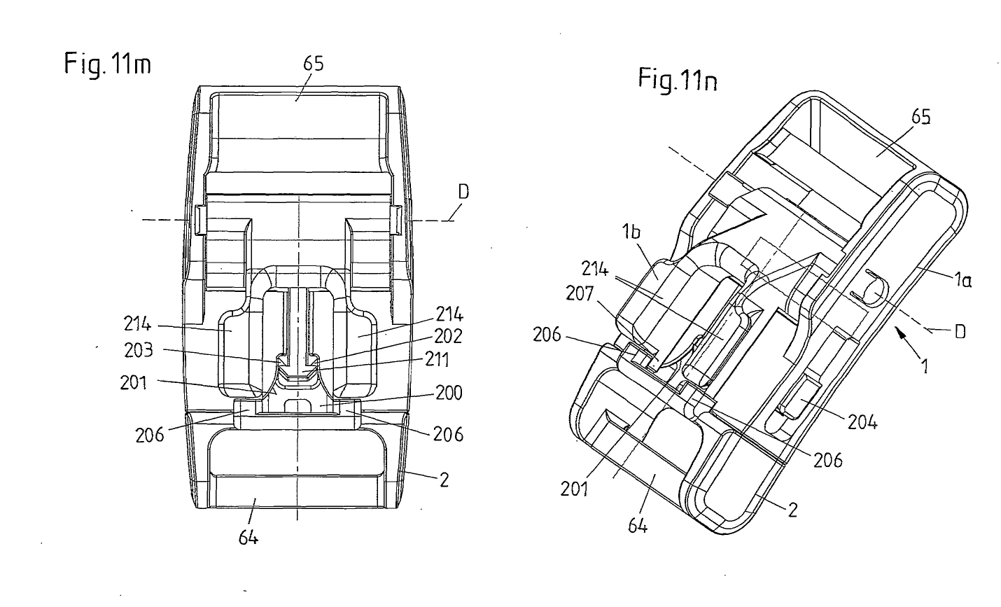

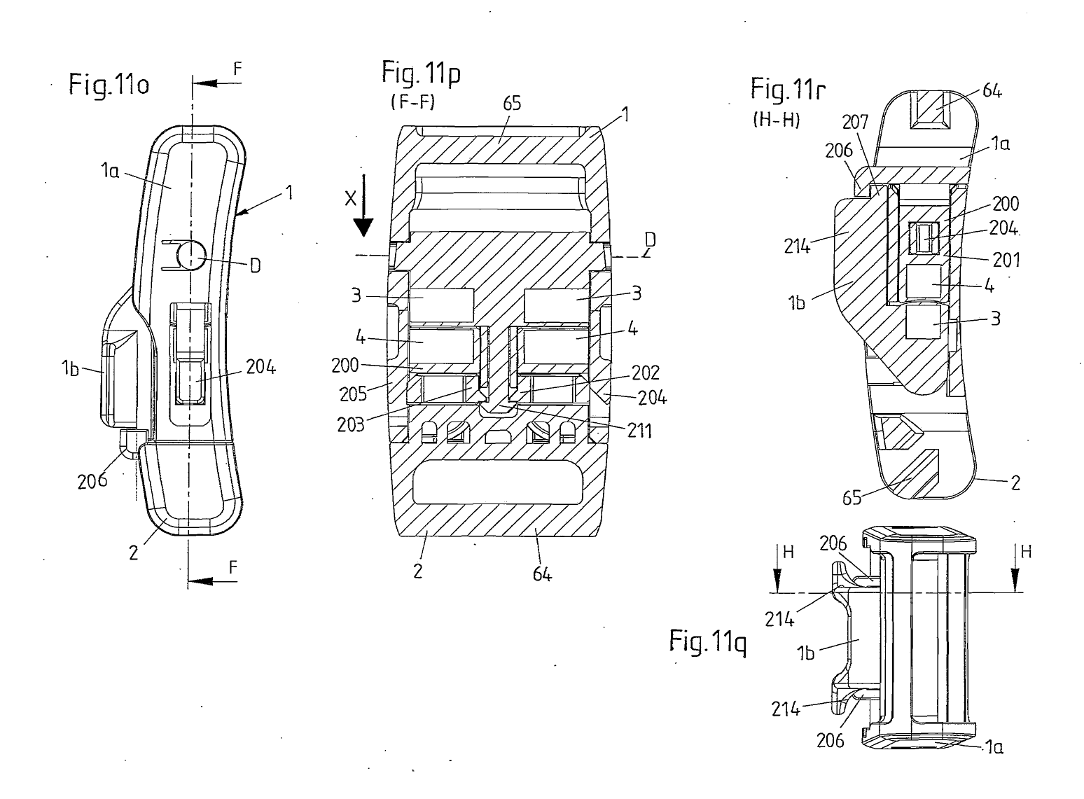

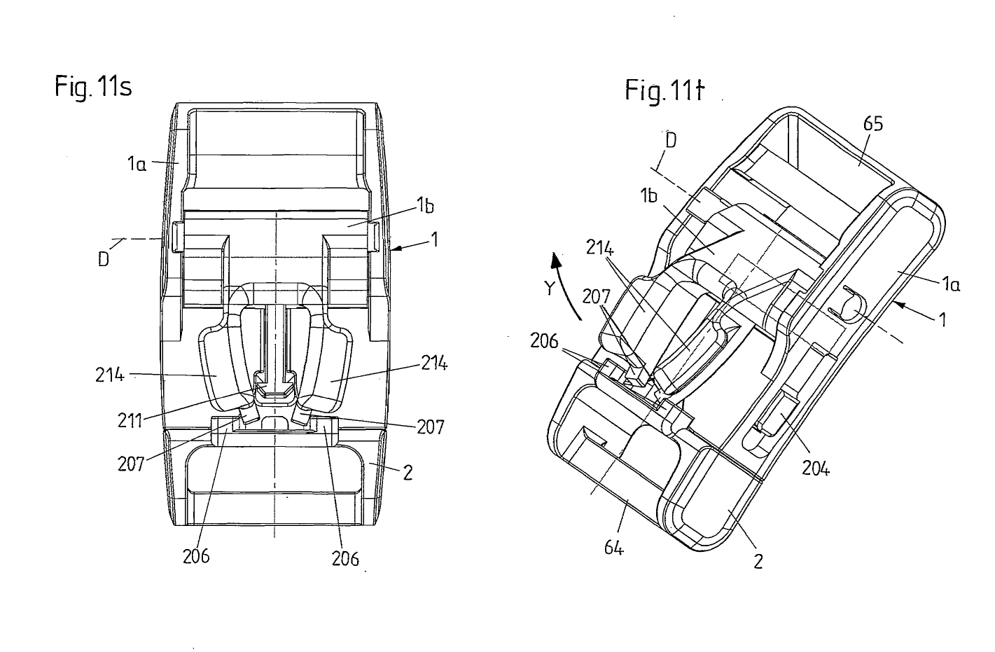

FIGS. 11a-11v show views of yet another further embodiment of a lock device as a kind of clip buckle having a pivotable actuating lever, however, having a locking device which is modified compared with the embodiment according to FIGS. 10a-10f.

FIGS. 1a to 1e show a first exemplary embodiment of a lock device having a first connecting module 1 and a second connecting module 2. The lock device can for example be used as a lock for a bag, a backpack, a suitcase or any other container or as a rope link or strap link or be employed everywhere, where two elements are to be connected to each other enduringly and detachable.

FIG. 1a shows the lock device in a closing position, in which the first connecting module 1 and the second connecting module 2 are mechanically catch-lockingly engaged with each other, in that spring lock elements 5a, 5b, arranged on the second connecting module 2, engage positive-lockingly with edges of the first connecting module 1, serving as blocking pieces 6a, 6b, so that the connection of the first connecting module 1 and the second connecting module 2 is mechanically secured against a load acting contrary to a closing direction X.

For the realization of magnetic means as a kind of a magnet-anchor system a magnet 3, 4 each (or on the one hand a magnet and on the other hand a magnetic anchor) is arranged on the first connecting module 1 and the second connecting module 2 respectively, which in the closing position, illustrated in FIG. 1a, stand frontally opposite to each other with contrary poles and attract each other magnetically. The magnetic means 3, 4 serve to support the closing process and to cause the establishing of the mechanical catch locking engagement largely automatically, so that the lock device is lockable in an easy and, for a user, haptically pleasant manner.

The lock device, illustrated in the closing position in FIG. 1a, can be opened by moving the first connecting module 1 in an opening direction Y, pointing transverse to the closing direction, relative to the second connecting module 2. Hereby, the edges of the first connecting module 1, serving as blocking pieces 6a, 6b, slide out of engagement with the spring lock elements 5a, 5b (see FIG. 1c), so that the first connecting module 1 can be taken away from the second connecting module 2 (see FIG. 1d).

To prevent an unintended opening of the lock device, a locking device is provided which prevents a lateral opening movement in the opening direction Y between the spring lock elements 5a, 5b and the blocking pieces 6a, 6b. The locking device is in the exemplary embodiment according to FIGS. 1a to 1e formed by a locking element 7 in the form of a locking bolt, which is guided movably on the first connecting module 1 and in the closing position according to FIG. 1a engages with an allocated, matching recess 8 (see FIG. 1e) on the second connecting module 2 in such a way that the first connecting module 1 cannot be shifted in the opening direction Y.

The locking element 7 can be pre-loaded in a locking position against the first connecting module 1 by the use of a mechanical spring in such a way that upon closing the lock device it automatically comes into the locking position, illustrated in FIG. 1a.

The locking element 7 on its end which engages with the recess 8 can be formed, for example be bevelled, in such a way that a movement in the opening direction Y is blocked, but not a movement in another direction, for example a movement counter to the opening direction Y.

To open the lock device the locking device is to be unlocked by actuating the locking element 7 in that the locking element 7 is removed from the recess and thereby the positive-locking locking is terminated. FIG. 1b shows the lock device after unlocking. The locking element 7 is in this case actuated so far that it no longer engages with the recess 8 of the second connecting module 2, so that the first connecting module 1 is unlocked, i.e. can be shifted in the opening direction Y.

In the position illustrated in FIG. 1c the first connecting module 1 is so far shifted relative to the second connecting module 2 in the opening direction Y that the blocking pieces 6a, 6b and the spring lock elements 5a, 5b are laterally brought out of engagement, without the spring lock elements 5a, 5b having been spread for this purpose. At the same time, by the movement in the opening direction Y the magnets 3, 4 have been tangentially shifted relative to each other with their poles facing each other, so that the magnetic attracting force of the magnets 3, 4 has weakened and detaching the first connecting module 1 from the second connecting module 2 is readily possible. As the forces to be applied both for releasing the catch locking engagement by lateral shifting and for the shearing removal of the magnets 3, 4 away from each other are small, pleasant haptics also for opening are the result.

FIG. 1d shows the lock device in the opened state with connecting modules 1, 2 separated from each other. The magnets 3, 4 are spatially separated from each other, and the catch locking engagement of the spring lock elements 5a, 5b and the blocking pieces 6a, 6b is positioned out of engagement.

When the lock device is to be closed again, the first connecting module 1, as shown in FIG. 1e, has to be brought into a position, in which it can mechanically catch-lockingly engage with the second connecting module 2. For this purpose, additional restoring means e.g. in the form of a mechanical return spring can be provided (not illustrated in FIG. 1e), which bring the first connecting module 1 into the position shown in FIG. 1e, that is move it counter to the opening direction Y into such a position, that the blocking pieces 6a, 6b can come into catch-locking engagement with the spring lock elements 5a, 5b.

Additional restoring means can also be dispensed with, in that the return is taken on by the magnetic attracting force of the magnets 3, 4. By the magnetic attracting force the first connecting module 1 is automatically pulled into a position in which it can catch-lockingly engage with the second connecting module 2, and the catch locking engagement is automatically established. A sufficiently strong dimensioning of the magnetic attracting force is a prerequisite.

To close the lock device the first connecting module 1 and the second connecting module 2 are attached onto each other, wherein the closing process takes place magnetically supported by the magnetic attracting force of the magnets 3, 4 and thus the catch locking engagement of the first connecting module 1 with the second connecting module 2 is essentially established automatically. When the locking element 7 has previously been returned by a spring pre-load into its locking position, upon closing in the closing direction X the locking element 7 also automatically engages with the recess 8 again, so that the lock device is secured against an unintended opening without a further actuation of the locking element 7.

In a second exemplary embodiment, illustrated in FIGS. 2a to 2f, a safeguard against an unauthorized opening, particularly for an anti-theft protection, is also provided by a locking device. The lock device has yet again a first connecting module 1a, 1b and a second connecting module 2, wherein the first connecting module 1a, 1b is made of two parts, namely a first module part 1a, formed as a movable slide serving as actuating element, and a second module part 1b, slidingly guiding the first module part 1a in the opening direction Y.

The same reference signs as in FIGS. 1a to 1e are assigned to components with the same function in the figures, as also in all subsequent exemplary embodiments, as far as this is useful.

At this point it shall be noted that the first connecting module 1a, 1b of the lock device can also be designed as one part, analogous to the embodiment according to FIGS. 1a to 1e.

A magnet 3 is arranged on the first module part 1a, which in the closing position (FIG. 2a) stands frontally attracting opposite to a magnet 4 (or a magnetic anchor) on the second connecting module 2. Moreover, blocking pieces 6a, 6b are arranged on the first connecting module 1a which in the closing position engage positive-lockingly with spring lock elements 5a, 5b on the second connecting module 2 and form a spring catch locking with the spring lock elements 5a, 5b. The spring catch locking and the strength of the magnets 3, 4 is herein measured in such a way that by the effect of the magnetic attracting force the catch locking is closed automatically.

The second module part 1b of the first connecting module is in the closing position (FIG. 2a) fixed via lateral guiding rails 12a-12d on the second connecting module 2 in such a way that it is not movable relative to the second connecting module 2, particularly not in the opening direction Y. In the closing position the first module part 1a is thereby together with the second module part 1b held onto the second connecting module 2.

To open the lock device the first module part 1a, which serves as actuating element, is moved in the opening direction Y relative to the second module part 1b, until the blocking pieces 6a, 6b come out of engagement with the spring lock elements 5a, 5b (see FIG. 2c). In the closing position the first module part 1a and the second module part 1b are here, however, locked with each other via a locking device, realized by locking elements 9a, 9b, 9c and actuating bolts 11a, 11b, 11c, so that opening the lock device is only possible when the locking device has previously been unlocked (FIG. 2b).

For the realization of the locking device multiple locking elements 9a, 9b, 9c are arranged on the second module part 1b, which are pre-loaded via return springs 10a, 10b, 10c against the second module part 1b and in the closing position engage with allocated recesses 90 of the locking of the first module part 1a, so that the first module part 1a cannot be shifted relative to the second module part 1b and is thereby fixed in the opening direction Y relative to the second connecting module 2.

By pushing in the actuating bolts 11a, 11b, 11c, which stand in operative connection with the locking elements 9a, 9b, 9c, the locking elements 9a, 9b, 9c can be brought out of engagement with the recesses 90 to release the locking between the first module part 1a and the second module part 1b. Here, in the locking position illustrated in FIG. 1a, not all the locking elements 9a, 9b, 9c engage with an allocated recess, wherein from outside it cannot be seen by a user which actuating bolts 11a, 11b, 11c are to be actuated and which are not and whether the individual locking elements 9a, 9b, 9c in the non-actuated state are positioned in locking engagement or not and whether they lock or unlock by the actuation.

In the present exemplary embodiment the actuating bolts 11a, 11b, 11c are to be actuated so that the locking elements 9a, 9b, 9c are pushed into the second module part 1b against the force of the respective return spring 10a, 10b, 10c and stop at a predetermined position. Two variants of bolt lengths of the locking elements 9a, 9b, 9c are provided:

Either the length of the upper actuating bolt 11a, 11b, 11c and lower locking element 9a, 9b, 9c is measured in such a way that the plane of osculation of the upper actuating bolt 11a, 11b, 11c and the lower locking element 9a, 9b, 9c lies specifically on the shifting plane between the first module part 1a and the second module part 1b. The locking element 9a, 9b, 9c is in this case unlocked in the non-actuated state, i.e. without actuation it does not stand opposed to a shifting of the first module part 1a and the second module part 1b, but blocks after actuation.

Or the length of the upper actuating bolt 11a, 11b, 11c and lower locking element 9a, 9b, 9c is measured in such a way that only after an actuation the plane of osculation of the upper actuating bolt 11a, 11b, 11c and the lower locking element 9a, 9b, 9c lies in the shifting plane of the first module part 1a and the second module part 1b. In this case the locking element 9a, 9b, 9c locks in the non-actuated state and is unlocked by an actuation.

Multiple such bars together form a combination lock, which with an increasing number of bars offers more and more combination possibilities.

In FIG. 2b the lock device is illustrated in the unlocked state. The actuating bolts 11b, 11c are pushed in and the allocated locking elements 9b, 9c are unlocked. The first module part 1a can, thereby, be shifted in the opening direction Y to open the lock device.

FIG. 2c shows the lock device after the lateral shift of the first module part 1a in the opening direction Y (directed transverse to the closing direction X) in the non-engaged position, in which on the one hand the magnets 3, 4 are shifted relative to each other and on the other hand the spring catch locking of the blocking pieces 6a, 6b and the spring lock elements 5a, 5b is laterally brought out of engagement. The lock device can in this state be released.

In FIG. 2d the two connecting modules 1a, 1b, 2 are illustrated in the opened state completely separated from each other.

In the position illustrated in FIG. 2e the first module part 1a, designed as a slide, is returned into a position, in which the blocking pieces 6a, 6b can again be catch-lockingly engaged with the spring lock elements 5a, 5b to close the lock device. The return can take place manually, by suitable design of the magnets 3, 4 (or anchors) or by additional restoring means e.g. in the form of a mechanical return spring, which pre-load the first module part 1a against the second module part 1b in the direction of the catch locking position, illustrated in FIG. 2e.

Caused by the return springs 10a, 10b, 10e (FIG. 2f), furthermore, also the locking elements 9a, 9b, 9c are returned into their starting position.

The locking device of the exemplary embodiment according to FIGS. 2a to 2f can be further developed in that an opening means of the kind of a key actuates the locking elements 9a, 9b, 9c in a due manner after an adjusted insertion by correspondingly pre-formed pins. In this case, only the inserting and shifting (or turning) of the opening means is required for opening. It is then also possible that a locking element 9a, 9b, 9c can assume not only two positions, but e.g. three or more, so that an unlocking only takes place when the respective locking element 9a, 9b, 9c has been shifted into the correct position, which strongly increases the number of possible combinations.

In a further exemplary embodiment of a lock device in the form of a strap buckle, e.g. for the use as a buckle for a helmet, illustrated in FIGS. 3a to 3f, in a closing position a second connecting module 2 in the form of a so-called male part engages with a first connecting module 1 in the form of a so-called female part and can only be detached again by a lateral shifting in an opening direction Y, however, only after unlocking by actuating an unlocking button 17.

FIGS. 3b and 3c show the lock device with its individual parts in two exploded views in a diagonal top angle perspective (FIG. 3b) and in a diagonal low angle perspective (FIG. 3c).

A spring lock element 5 in the form of a spreading ring, which is arranged on a base plate 20 in such a way that the spring lock element 5 state can move aside in a radial direction to establish the closing, is part of the second connecting module 2 (female part). A magnet 3 is arranged on the base plate 20 in such a way that after the closing it lies attracting opposite a magnet 4 on the first connecting module 1 (male part).

In a closing position (FIG. 3a, 3e) a blocking piece 6 in the form of a mushroom-shaped knob engages positive-lockingly with the spring lock element 5 in the form of the spreading ring and thereby catch-lockingly connects the first connecting module in a positive-locking manner to the second connecting module 2.

To establish the closing position the first connecting module is attached onto the second connecting module 2 in the closing direction X, so that the blocking piece 6 catch-lockingly engages with the spring lock element 5 (FIG. 3f). Establishing the catch locking engagement takes place by the magnetic attraction of the magnets 3, 4 (one of which can also be constructed as a magnetic anchor) largely automatically upon attaching the first connecting module 1 onto the second connecting module 2.

The spring lock element 5 in the form of the spreading ring has a lateral recess 53, so that the spring lock element 5 is not closed circumferentially, but instead is open to one side. Thereby, it is possible, by shifting the first connecting module 1 relative to the second connecting module 2 in the opening direction Y transverse to the closing direction X, to shift the spring lock element 5 out of engagement with the blocking piece 6, so that the catch-locking, positive-locking connection of the first connecting module 1 to the second connecting module 2 is terminated and the lock device can be released. By the shifting in the opening direction Y at the same time the magnets 3, 4 are also removed from each other so that their magnetic attracting force weakens and the first connecting module 1 can readily and in a haptically pleasant manner be detached from the second connecting module 2.

In the closing position a locking element 9, arranged on the second connecting module 2, engages with an allocated recess 8 on the first connecting module 1 (see FIG. 3c) in such a way that the first connecting module 1 counter to a movement in the opening direction Y is locked with the second connecting module 2. The locking element 9 is elastically arranged on the second connecting module 2 via a return spring 10a in the form of an elastic section, so that the locking is established automatically when the first connecting module 1 comes into the closing position on the second connecting module 2.

To unlock the lock device, the unlocking button 17 has to be actuated, which is mounted movable via an actuating bolt 11 on the second connecting module 2 on a guiding rail 13 in the form of a shaft-like recess. The actuating bolt 11 stands in operative connection with the locking element 9 on the first connecting module 1 and acts, upon actuating the unlocking button 17, by applying a compressive force in the closing direction X upon the locking element 9 in such a way that the locking element 9 comes out of engagement with the recess 8 on the second connecting module 2 (FIG. 3e).

After actuating the unlocking button 17 the first connecting module 1 can be shifted in the opening direction Y relative to the second connecting module 2. FIG. 3d shows the first and the second connecting module 1, 2 after the shift in the opening direction Y has taken place. The connecting modules 1, 2 are separated from each other, the lock device is opened.

A further exemplary embodiment of a lock device, illustrated in various partial sectional views in FIGS. 4a to 4f and in an exploded view in FIG. 4g, is designed as a rotation lock, in which a first connecting module 1 is in a closing position mechanically catch-lockingly engaged with a second connecting module 2 and can be detached from the second connecting module 2 by turning a module part 1a in the form of a rotary knob.

The lock device has four magnets 3a, 3b, 4a, 4b, of which the magnets 3a, 3b are arranged on a rotation core 1a′, fixedly connected to the module part 1a, and the magnets 4a, 4b are arranged on a base plate 20 of the second connecting module 2. The magnets 3a, 4a and 3b, 4b attract each other in pairs, wherein by turning the magnets relative to each other—analogously to as this is specified for example in WO 2008/006357 A2—the magnetic attracting force can be weakened and be reversed into a magnetic repulsion.

As can be seen in the exploded view according to FIG. 4g, the first connecting module 1 is made of a rotary functional module, consisting of the module part 1a in the form of the rotary knob and the rotation core 1a′, and a fixed functional module, made of a module part 1b and a ring-shaped thrust bearing 1b′, arranged torque-proof on said module part 1b.

The second connecting module 2 has a fixed module part 23, on which a spring lock element 5 in the form of a spreading ring, in sections open towards the side, and a base plate with the magnets 4a, 4b are arranged torque-proof.

The spring lock element 5 has locking catches 50a, 50b, which in a closing position engage positive-lockingly with blocking pieces 6a, 6b of the kind of locking catches on the rotation core 1a′ and catch-lockingly connect the first connecting module 1 to the second connecting module 2 in a positive-locking manner.

The magnets 3a, 3b and 4a, 4b are polarized in pairs in such a way that upon attaching the first connecting module 1 onto the second connecting module 2 to close the lock device in the closing direction X unlike poles mutually attract each other and cause a turning of the rotation core 1a′ together with the module part 1a into a position, in which the blocking pieces 6a, 6b of the rotation core 1a′ can enter into engagement with the locking catches 50a, 50b of the spring lock element 5. For this purpose, on the one hand the magnets 3a, 3b have unlike poles (N and S) on their side facing the second connecting module 2 and on the other hand the magnets 4a, 4b also have unlike poles (S and N) on their side facing the first connecting module 1, so that in a turning position a torque and at the same time a magnetic attracting force into the due closing position is created.

FIG. 4a and FIG. 4d show the lock device in its closing position, wherein in FIG. 4d the spring catch locking, established via the spring lock element 5 and the blocking pieces 6a, 6b by positive-locking encompassing, is visible. The magnets 3a, 3b of the rotation core 1a′ and the magnets 4a, 4b of the second connecting module 2 here lie frontally with unlike poles and thereby attracting opposite to each other.

On the first connecting module 1a locking device is provided having actuating bolts 11a-11f, arranged on the module part 1a and guided in recesses 14a-14f, which stand in operative connection with locking elements 9a-9f, mounted elastically on the thrust bearing 1b′ via return springs 10a-10f, wherein the locking elements 9a-9f in a locking position engage lockingly with the recesses 14a-14f and can be unlocked by actuation via the actuating bolts 11a-11f.

Yet again, the locking device can realize a combination lock, in which predetermined actuating bolts 11a-11f have to be actuated for unlocking, analogous to as this has been specified above.

Analogous to as it is specified above, the locking elements 9a-9f and also the actuating bolts 11a-11f have, depending on the predetermining, one of two different lengths:

Either the locking element 9a-9f is not actuated in the locking position, i.e. it is so long that in the non-actuated state it blocks the module part 1a (and thereby also the rotation core 1a′) and is upon actuation pushed by the actuating bolt 11a-11f in the unlocking position. This is the case in the present exemplary embodiment e.g. in the locking element 9c.

Or the locking element 9a-9f lies non-actuated in the unlocking position, i.e. it is so short that in the non-actuated state it gives free the module part 1a. Upon actuation, however, the locking element 9a-9f engages with the thrust bearing 1b′ and locks the module part 1a. This is the case in the present exemplary embodiment e.g. in the locking element 9a.

FIG. 4b shows the lock device in the unlocked state after pushing the predetermined actuating bolts 11a-11f, which unlock the locking elements 9a-9f in such a way that the module part 1a can be turned in the opening direction Y. The combination of the actuating bolts 11a-11f and locking elements 9a-9f is here determined in advance upon installation, wherein essentially also embodiments of the locking device, to be actuated by a key or a numerical code, are conceivable, which can, where applicable, also be subsequently programmable, i.e. can be set to a key or a code.

FIG. 4c shows the lock device after a partial turning of the first module parts 1a and thereby also of the rotation core 1a′ in the opening direction Y. The catch locking engagement in this position is still engaged, and the magnets 3a, 3b, 4a, 4b still stand attracting opposite to each other.

In the position illustrated in FIG. 4e, after turning the module part 1a in the opening direction Y, the magnets 3a, 3b, 4a, 4b are turned relative to each other in such a way that they stand opposite to each other at least in sections with like poles (i.e. the magnet 3a stands in sections opposite to the magnet 4b and the magnet 3b to the magnet 4a), so that the force of the magnets 3a, 3b, 4a, 4b, attracting in the closing position, reverses into a force of repulsion. At the same time, the blocking pieces 6a, 6b of the rotation core 1a′ have come out of engagement with the locking catches 50a, 50b of the spring lock element 5, so that the rotation core 1a′ can be taken out from the second connecting module 2 and thereby the first connecting module 1 altogether—magnetically supported by the repulsive force of the magnets 3a, 3b, 4a, 4b turned relative to each other—can be detached from the second connecting module 2 in a simple and haptically pleasant manner.

FIG. 4f shows the lock device in the opened state. To close the lock device again, the first connecting module 1 can yet again be attached onto the second connecting module 2, wherein the rotation core 1a′ is turned by the attracting force of the magnets 3a, 3b, 4a, 4b into its position required for the catch locking engagement, and the catch locking engagement is, moreover, established automatically or almost automatically by the magnetic attracting force acting between the magnets 3a, 3b, 4a, 4b.

In a further exemplary embodiment of a lock device in the form of a rotation lock, illustrated in FIGS. 5a and 5b, the first connecting module 1 has three spring lock elements 5a, 5b, 5c having thread-shaped locking catches 50a, 50b, 50c, which in the closing position engage positive-lockingly with blocking pieces 6a, 6b, 6c in the form of locking catches on the second connecting module 2.

To establish the closing position the first connecting module 1 is attached onto the second connecting module 2 in the closing direction X, so that the spring lock elements 5a, 5b, 5c come into catch-locking engagement with the blocking pieces 6a, 6b, 6c of the second connecting module 2.

Two magnets 3a, 3b are arranged on the first connecting module 1 and two magnets 4a,4b are arranged on the second connecting module 2, which attract each other in pairs in such a way that—analogous to as it has been explained above with the help of the embodiment according to FIGS. 4a to 4g—the catch-locking connection of the connecting modules 1, 2 is automatically established in a magnetically supported manner, wherein the polarity of the magnets 3a, 3b, 4a, 4b at the same time also has the effect that the connecting modules 1, 2 are, upon establishing the connection, turned relative to each other into their due position for the catch-locking connection.

In the closing position the magnets 3a, 3b, 4a, 4b stand frontally attracting opposite to each other in pairs. To open the lock device the first connecting module 1 can be screwed in the opening direction Y relative to the second connecting module 2 in such a way that the thread-shaped locking catches 50a, 50b, 50c are screwed in the opening direction out of engagement with the likewise thread-shaped blocking pieces 6a, 6b, 6c. By the screwing movement the magnets 3a, 3b, 4a, 4b are also turned relative to each other, so that the magnetic attracting force, acting in the closing position, weakens and in the opened position is reversed into a repulsive force, so that taking out the first connecting module 1 from the second connecting module 2 can take place in a magnetically supported manner.

In the exemplary embodiment according to FIGS. 5a, 5b a locking device in the form of a bolt-shaped locking element 7, shiftably arranged on the first connecting module 1, is provided, which in the locked position lockingly engages with a recess 8 on the second connecting module 2 in such a way that turning the first connecting module 1 relative to the second connecting module 2 is not possible out of the closing position. The lock device is thereby secured in the closing position, wherein the locking element 7 can be pre-loaded relative to the first connecting module 1 (for example via a mechanical spring) in such a way that the locking element 7 upon closing the lock device comes automatically into its locking position. To open the lock device the locking element 7 has first to be actuated to then be able to turn the connecting modules 1, 2 against each other in the opening direction Y.

In a lock device illustrated in FIGS. 6a to 6i—analogous to the lock device illustrated in WO 2009/010049 A2—on blocking pieces 6a, 6b of a second connecting module 2, which in the closing position positive-lockingly engage with locking catches 50a, 50b of a spring lock element 5 on a first connecting module 1, force-deflecting run-up slopes 19a, 19b are provided, which upon a linear shifting of the first connecting module 1 in the opening direction Y push the locking catches 50a, 50b, elastic via spring legs 51a, 51b, out of engagement with recesses 19 of the blocking pieces 6a, 6b.

FIG. 6a shows the lock device in an exploded view. On the first connecting module 1a longitudinally extending, wedge-shaped plugging section 18 is formed, which for establishing the closing position is inserted into a plug housing 22 of the second connecting module 2, so that the blocking pieces 6a, 6b on the side of the plugging section 18 facing the second connecting module 2 come into engagement with the spring lock element 5, arranged on the plug housing 22, designed for example as sheet metal spring.

Two magnets 3a, 3b, 4a, 4b each are arranged on the connecting modules 1, 2, which in the closing position stand frontally attracting opposite to each other in pairs and are constructed in such a way that the catch-locking connection of the connecting modules 1, 2 is established largely automatically. The magnets 3a, 3b, 4a, 4b here at the same time also have the effect that the plugging section 18 of the first connecting module 1 and the plug housing 22 of the second connecting module 2 upon establishing the closing position are brought into their due position relative to each other, so that the locking catches 50a, 50b of the spring lock element 5 can come into positive-locking engagement with the blocking pieces 6a, 6b.

To release the connection the first connecting module 1 is shifted relative to the second connecting module 2 in the opening direction Y, so that the locking catches 50a, 50b run up onto the run-up slopes 19a and are thereby pushed out of engagement with the blocking pieces 6a, 6b, so that the first connecting module 1 can with its plugging section 18 be taken out of the plug housing 22 of the second connecting module 2.

FIGS. 6b and 6c show the lock device in the closing position and in a position shifted to open, FIGS. 6d and 6e show the lock device in cross section along the line A-A according to FIG. 6b or 6c, FIGS. 6f and 6g show the lock device in cross section along the line B-B according to FIG. 6d or 6e, and FIGS. 6h and 6i show the lock device in cross section along the line C-C.

As is evident from the comparing views in the closing position (FIG. 6b, 6d, 6f, 6h), in the closing position the locking catches 50a, 50b are in positive-locking engagement with the blocking pieces 6a, 6b, and at the same time the magnets 3a, 3b, 4a, 4b lie frontally attracting opposite to each other in pairs (see FIG. 6h).

To open, the first connecting module 1 is shifted in the opening direction Y (FIGS. 6c, 6e, 6g, 6i), so that the locking catches 50a, 50b by running up onto the run-up slopes 19a are pushed out of the recess 19, located underneath the blocking pieces 6a, 6b, and the positive-locking engagement is terminated (see FIG. 6g). Thereby, at the same time also the magnets 3a, 3b, 4a, 4b are shifted relative to each other, so that in the position (FIG. 6i) shifted relative to each other, the magnets 3a, 4b with like poles stand repulsing opposite to each other and the magnetic attracting force acting in the closing position (FIG. 6h) is reversed into a force of repulsion, which magnetically supports taking away the first connecting module 1 from the second connecting module 2 by force action counter to the closing direction X. In this manner, the first connecting module 1 can readily be taken away from the second connecting module 2.

The shifting of the connecting modules 1, 2 out of the closing position is blocked by a locking device in the form of a locking element 7, which is movably arranged on the first connecting module 1, lockingly engages with a recess 8 on the second connecting module 2 in the locked position and is to be actuated to open the lock device by being pulled out of the recess 8 (see FIGS. 6h and 6i).

The lock device according to FIGS. 6a to 6i can for example be used for bags or satchels. The connecting modules 1 and 2 can for this purpose be fastened onto a bag, wherein the fastening can essentially take place in various manners, e.g. by sewing, adhesive bonding, riveting or screwing.

An exemplary embodiment of a lock device, illustrated in FIGS. 7a to 7g, is constructed as a clip buckle, in which a first connecting module 1 is designed as plug housing and a second connecting module 2 as plug, which each have a strap link 64, 65 (FIG. 7a) for fastening a strap. FIG. 7a shows the lock device in a perspective view in the closed state, FIG. 7b in a side view, FIG. 7c in a sectional view along the line C-C according to FIG. 7b, and FIG. 7d in a sectional view along the line D-D according to FIG. 7b. In FIG. 7e a module part 1b of the first connecting module 1, constructed as actuating element in the form of an actuating lever, and the second connecting module are illustrated in separate views. FIG. 7f shows the lock device in a side view in a partially cut-clear manner in a state actuated for opening, and FIG. 7g shows the lock device in a sectional view along the line C-C according to FIG. 7f.

The first connecting module 1 has a first module part 1a in the form of a casing and a second module part 1b in the form of an actuating lever, which is arranged pivotable on a swivel axis D on the first module part 1a. Blocking pieces 6a, 6b are provided on the first module part 1a (see FIG. 7c), which in the closing position (FIGS. 7a, 7b, 7c, 7d) engage positive-lockingly with spring lock elements 5a, 5b in the form of locking catches on the second connecting module 2 and thereby lock the first connecting module 1 with the second connecting module 2.

To open the lock device the second module part 1b in the form of the actuating lever of the first connecting module 1 can be pivoted, whereby the spring lock elements 5a, 5b, with run-up slopes 52a, 52b arranged upon them, run up onto run-up slopes 19a, 19b on the module part 1b and are thereby, as illustrated in FIG. 7g, pushed out of engagement with the blocking pieces 6a, 6b. The run-up slopes 19a, 19b, 52a, 52b of the spring lock elements 5a, 5b and of the module part 1b are bevelled in a corresponding manner, so that upon a pivoting movement of the module part 1b on the swivel axis D in the opening direction Y the run-up slopes 19a, 19b, 52a, 52b run up onto each other and push the elastic spring lock elements 5a, 5b out of engagement with the fixedly arranged blocking pieces 6a, 6b.

The run-up slopes 19a, 19b, 52a, 52b, moreover, act as ejection support in that they, in the actuated state (FIG. 7g), caused by their slopes create a force in the direction of ejection (counter to the closing direction X) and thereby mechanically support the release of the lock device.

On each the second module part 1b in the form of the actuating lever of the first connecting module 1 and on the second connecting module 2 a magnet 3, 4 is arranged respectively, which point towards each other with different poles and which hence attract each other to establish the closing position and in the closing position of the lock device. The magnets 3, 4 (one of which can also be constructed as a magnetic anchor) are here dimensioned in such a way that upon attaching the first connecting module 1 onto the second connecting module 2 the catch-locking connection of the spring lock elements 5a, 5b to the blocking pieces 6a, 6b is established in an automatic manner so that closing the lock device can take place simply and in a haptically pleasant manner.

Upon opening the lock device (FIG. 7f) also the magnets 3, 4 are pivoted relative to each other by actuating the module part 1b, so that the magnetic attracting force of the magnets 3, 4 is weakened and the first connecting module 1 can be detached from the second connecting module 2 without great effort.

Additionally, a locking device in the form of a hook-like locking element 7, arranged movably in a shifting direction V on the module part 1b, is provided, which in the locked state engages with the second connecting module 2 in such a way that the module part 1b cannot be pivoted on the swivel axis D relative to the second connecting module 2. Thereby, the lock device is locked and secured in its closing position and can only be opened when the locking element 7 has been moved in the shifting direction V out of its locking engagement.

Other locking devices are also conceivable here, which are to be actuated for example by a key or by entering a numerical code.

A lock device illustrated in FIGS. 8a to 8f is designed as a lock for strap ends on backpacks or bags or also for the holder of an ice pick or the like on a backpack. The lock device has two connecting modules 1, 2, the first connecting module 1 of which is configured with a module part 1b, like a casing, and a module part 1a, which can be rotated relative to the module part 1b, in the form of an actuating element.

The module part 1a has a rotation core 1a′, on which a blocking piece 6 in the form of a ring-shaped locking catch is arranged on the end of the rotation core 1a′ which is facing the second connecting module 2.

The blocking piece 6 in a closing position of the lock device engages positive-lockingly with locking catches 50a, 50b of a ring-shaped, elastic spring lock element 5, which is arranged torque-proof on a base plate 20 of the second connecting modules 2. The base plate 20 is connected to a module part 23, wherein the locking catches 50a, 50b of the spring lock element 5 reach through recesses 230 of the module part 23.

FIG. 8a shows the lock device in an exploded view and FIG. 8b in a top view. FIG. 8c and FIG. 8d show cross-sectional views, wherein the lock device in the illustration in FIG. 8c is positioned in the closing position and in FIG. 8d is shown in the actuated state. FIGS. 8e and 8f show sectional views along the line A-A according to FIG. 8c or 8d.

In the closing position (FIG. 8c, 8e) the rotation core 1a′ of the first connecting module 1 engages with a cylindrical housing opening 231 of the module part 23 of the second connecting module 2 and engages positive-lockingly via the blocking pieces with the locking catches 50a, 50b of the spring lock element 5, so that the first connecting module 1 is held on the second connecting module 2.

Two magnets 3a, 3b, 4a, 4b each are arranged on the rotation core 1a′ and on the module part 23 respectively, which magnetically attract each other to close the lock device and are here planned in such a way that they establish the catch-locking connection largely automatically (in other words, the magnets 3a, 3b, 4a, 4b are dimensioned in such a way that the magnetic attracting force exceeds the force required to establish the catch locking connection). The magnets 3a, 3b, 4a, 4b here also act restoringly in that they turn the rotation core 1a′ by the effect of the magnetic attracting force into a position, in which the blocking piece 6 can lock with the locking catches 50a, 50b. For this purpose the magnets 3a, 3b have on their side facing the magnets 4a, 4b unlike poles, as vice versa also the magnets 4a, 4b have unlike poles, wherein the magnets 3a, 4a and 3b, 4b attract each other in pairs (see FIG. 8c).

To open the lock device the module part 1a in the form of the rotary actuating lever can be turned in the opening direction Y, whereby also the rotation core 1a′ in the housing opening 231 of the module part 23 is turned. To bring the locking catches 50a, 50b out of engagement with the blocking piece 6, on the rotation core 1a′ above the blocking piece 6 run-up slopes 19a and unlocking sections 19c are arranged, which are constructed in such a way that upon turning the rotation core 1a′ out of the closing position (FIG. 8e) the locking catches 50a, 50b run up onto the run-up slopes 19a and after the turn by a predetermined angle in the opening direction Y come into the area of the unlocking sections 19c. By running up onto the run-up slopes 19a the locking catches 50a, 50b are pushed out of engagement with the blocking piece 6 so that the positive-locking engagement is terminated when the locking catches 50a, 50b are positioned in the area of the unlocking sections 19c (FIG. 8f).

By turning the rotation core 1a′ at the same time also the magnets 3a, 3b, 4a, 4b are turned relative to each other, so that in the non-engaged position (FIGS. 8d, 8f) the magnets 3a, 4b and 3b, 4a stand opposite to each other with like poles at least predominantly and create a repulsive magnetic force, supporting the opening, so that the first connecting module 1 can in an easy and pleasant manner be taken away from the second connecting module 2.

The ring-shaped spring lock element 6 with its ring section is planned especially softly elastic and thereby offers especially soft haptics with, at the same time, a stable mechanical locking by transverse tension on the locking catches 50a, 50b. The locking catches 50a, 50b are each bevelled in such a way that they, to close the lock device, in the closing direction can come into catch-locking engagement with the blocking piece 6 in a positive-locking manner. A locking device is realized in the exemplary embodiment according to FIGS. 8a to 8f by a locking element 7 in the form of a bolt, movably arranged on the module part 1a, which in the locked position (FIG. 8c) engages with a recess 8 on the module part 1a of the first connecting module 1, so that the module part 1a cannot be turned relative to the second module part 1b. To open the lock device the locking element 7 has to be actuated, i.e. be pulled out of the recess 8 (FIG. 8d), so that turning the module part 1a becomes possible.

FIGS. 9a to 9k show different views of a further embodiment of a lock device, in which the locking device is not formed by a locking element, which is arranged separately on one of the connecting modules, but by the engagement of a locking element 102, fixedly arranged on one of the connecting modules 1, 2, with a groove 101 on the other of the connecting modules 1, 2, wherein the locking device can be unlocked by a rotation movement of the first connecting module 1 in an unlocking direction Z (corresponding to a direction of rotation) on the closing direction X. FIG. 9a shows here an overview, FIGS. 9b and 9c show exploded views once in a diagonal top angle perspective and once in a diagonal low angle perspective, FIG. 9d shows an exploded view in section, FIG. 9e an exploded view as viewed from the side, FIGS. 9f and 9g the lock device in the released state and FIGS. 9h to 9k sectional views of the lock device in the closed, locked state (FIG. 9h), in the closed but unlocked state (FIG. 9i), in the opened state (FIG. 9j) and prior to closing the lock device (FIG. 9k).

The lock device according to FIGS. 9a to 9k is basically designed according to the kind of lock device illustrated in FIGS. 3a to 3f. As far as is useful, in this case as also subsequently, the same reference signs are assigned to components with the same function, wherein additional components and, where applicable, also components which are modified in their function are designated other reference signs.

The first connecting module 1 in the lock device according to FIGS. 9a to 9k has a blocking piece 6 in the form of a protruding pin, carrying a ring-shaped locking catch, which is designed to come into catch-locking engagement with a spring lock element 5 in the form of a laterally opened ring element, arranged in a housing 114 on the second connecting module 2, as this has analogously been specified above in connection with the embodiment according to FIGS. 3a to 3f. A magnet 4 is arranged on the blocking piece 6 of the first connecting module 1 and a magnet 3 is arranged on a base plate 20 of the second connecting module 2, which cause a magnetic attracting force between the connecting modules 1, 2 and at least support the transfer of the lock device into its closing state, in which the spring lock element 5 is mechanically catch-lockingly engaged with the blocking piece 6.

With respect to the embodiment according to FIGS. 9a to 9k it shall be noted that the lock device can essentially also be configured without magnetic means 3, 4 and in this case would be designed as a purely mechanical lock device. The magnetic means in the form of the magnets 3, 4 or on the one hand a magnet 3, 4 and on the other hand a magnetic anchor serve to magnetically support the closing movement. When the magnetic means 3, 4 are dispensed with, the locking can be caused by attaching the connecting modules 1, 2 onto each other by application of force from outside when establishing the mechanical catch locking engagement via the blocking piece 6 and the spring lock element 5.

As illustrated in the exploded views according to FIGS. 9b and 9c the first connecting module 1 is arranged on a component 112, for example the cover of a bag, in that the component 112 is held positive-lockingly between a module part 106 and a handle element 107, wherein the first connecting module 1 can be rotated relative to the component 112 in an opening 117. The second connecting module 2 is arranged fixedly on another component 113, for example the body of a bag, in that the component 113 is torque-proof clamped between a holding element 104 and a collar 115 of a module part 105 of the second connecting module 2 (see also FIGS. 9d and 9h).

The first connecting module 1 is made of the module part 106 and the handle element 107, which is connected torque-proof to the module part 106, wherein the module part 106 is via axially running bars 110, arranged on a cylindrical shell surface, positive-lockingly plugged into a recess 109 and grooves 111, which are arranged thereupon and are likewise running axially, so that the component 112 is held between the module part 106 and the handle element 107.

In the locked, closed state, illustrated in FIG. 9h, the spring lock element 5 engages catch-lockingly and positive-lockingly with the blocking piece 6, so that the first connecting module 1 cannot be removed counter to the closing direction X from the second connecting module 2. At the same time, the locking element 102, protrudingly arranged on the front side of the second connecting module 2 facing the first connecting module 1 and formed shaped like a circular arc, engages with the groove 101 on the first connecting module so that the first connecting module 1 cannot be moved in the opening direction Y (which runs transverse to the closing direction X) relative to the second connecting module 2. As evident from FIG. 9h, the locking element 102 is laying in this locked, closed state in the groove 101, which is confined outwards by a ring shoulder 100 (see also FIG. 9a).

Indeed, in the closed and locked state of the lock device, illustrated in FIG. 9h, a movement of the first connecting module 1 counter to the closing direction X and also in the opening direction Y transverse to the closing direction X is impossible. But the first connecting module 1 can be turned relative to the second connecting module 2 and thereby be moved in the unlocking direction Z, corresponding to a direction of rotation.

By turning the first connecting module 1 relative to the second connecting module 2 the lock device comes into the state illustrated in FIG. 9i, in which the locking element 102, arranged on the second connecting module 2, has been moved in the groove 101 in such a way that it comes to lie in the area of a recess 103 on the outer ring shoulder 100, and thus the locking element 102 is no longer blocked. The first connecting module 1 can in this position be moved in the opening direction Y relative to the second connecting module 2, in that the blocking piece 6 is moved through a lateral opening 118 of the housing 114 and is removed from the engagement with the spring lock element 5.

The state of the lock device, opened in such a way, is illustrated in FIG. 9j. In this state the first connecting module 1 has been moved in the opening direction Y relative to the second connecting module 2 and thereby been brought out of engagement with the second connecting module 2. The lock device is thus opened.

FIG. 9k shows the state prior to the renewed locking of the lock device. For the locking, the first connecting module 1 can in the closing direction X be attached onto the second connecting module 2, whereby the blocking piece 6 comes into catch-locking engagement with the spring lock element 5 and thereby establishes a mechanical catch locking engagement of the first connecting module 1 with the second connecting module 2.

To ensure that the locking device—made of the locking element 102, the groove 101 and the ring shoulder 100—locks automatically upon attaching the first connecting module 1 onto the second connecting module 2, restoring means can be provided, which for example by using a mechanical spring pre-load the first connecting module 1 into the position introduced in FIG. 9h. Instead of mechanical restoring means in the form of springs or the like it can, however, also be provided that the magnets 3,4, arranged on the first connecting module 1 and on the second connecting module 2, cause a magnetic attracting force not only in the closing direction X, but also around the closing direction X (for example by using two differently polarized pairs of magnets), so that on account of the magnetic means 3, 4 the first connecting module 1, upon attachment onto the second connecting module 2, is automatically brought into the desired locked position according to FIG. 9h on account of the acting magnetic forces.

In an alternative embodiment the first and the second connecting module 1, 2 can also be designed and arranged in such a way that gravity moves both connecting modules 1, 2 preferably into the locked position. For example, the first connecting module 1 could be attached on a mobile phone and the second connecting module 2 on a belt holder. The locking element 102, the groove 101 and the ring shoulder 100 are then advantageously adjusted in such a way that the mobile phone normally hangs vertically downwards like a pendulum in such a way that the connecting modules 1, 2 are securely locked relative to each other (see position according to FIG. 9h). To take off, the mobile phone is then rotated and unlocked until it can be taken out of its holder (this happens especially intuitively when the mobile phone is rotated by 180° and taken upwards out of the holder (second connecting module 2)).

Advantageously, the locking element 102 and the recess 103 are not exactly of the same size, but the recess 103 is in the circumferential direction slightly larger, so that unlocking the connecting modules can take place in a predetermined tolerance range of the rotation angle.

The lock device illustrated in FIGS. 9a to 9k is suited in an advantageous manner to form a combination lock, due to the fact that from outside with suitable design and arrangement it cannot be seen, in which position the lock device is unlocked.

The views according to FIGS. 9l to 9m show an exemplary embodiment of such a combination lock, wherein in the illustrated embodiment four lock devices of the kind specified previously according to FIGS. 9a to 9k have been combined, by arranging four first connecting modules 1 on a first component 112 and four second connecting modules 2 on a second component 113. The lock devices can be closed by attaching the connecting modules 1, 2 onto each other, as specified previously, wherein the lock devices in the closed state can only be opened by shifting the first connecting modules 1 in the opening direction Y together, when the first connecting modules 1 have each been brought into an unlocked position (see FIG. 9i).

In the present exemplary embodiment the opening direction Y is a linear shifting. Equally, the opening direction Y can also correspond to a rotation movement around a centre of rotation of the whole device. The recesses 103 of the individual connecting modules 1 in this case each lie tangentially to concentric circles around this centre (in the simplest case all recesses lie tangentially on a circle).

The result is a device, which can only be opened when the combination on the connecting modules 1 is correctly set, but which is locked when only one of the connecting modules 1 stands in a locked state with the second connecting module 2.

Obviously, other arrangements of the connecting modules 1, 2 and another number of lock devices are also conceivable, wherein by increasing the number of the connecting modules 1, 2 the combinatory security is increased.

As mentioned previously and evident for example from FIG. 9b, the first connecting module 1 consists of a handle element 107 and a module part 106, positive-lockingly plugged into this handle element 107. The module part 106 can here be plugged into the handle element 107 in various turning positions on the closing direction X, wherein by the turning position of the module part 106 the position of the lateral recess 103 in the ring shoulder 100 relative to the handle element 107 can be predefined. By plugging in the module part 106 the position of the handle element 107, in which the lock device is unlocked, can be predefined to in this manner set a numerical code for a combination lock of the kind illustrated in FIGS. 9l to 9m.

In FIGS. 10a to 10f an embodiment of a lock device as a kind of clip buckle is illustrated, wherein the lock device has a first connecting module 1, made of two module parts 1a, 1b, and a second connecting module 2, which with a plug element 200 can be plugged into a housing 201 on the first module part 1a of the first connecting module 1. The second module part 1b of the first connecting module 1 is mounted pivotable on a rotation axis D on the first module part 1a, wherein the second module part 1b is composed of a lock element 209 and an actuating element 208.

On each the plug element 200 of the second connecting module 2 and on the lock element 209 of the first connecting module 1 respectively, magnetic means in the form of two magnets 3, 4 or in the form of on the one hand a magnet and on the other hand a magnetic anchor are arranged, which magnetically support transferring the lock device into its closed state. To close the lock device, the first connecting module 1 is here with the housing 201, arranged on the first module part 1a, attached onto the plug element 200 of the second connecting module 2 and shifted onto the plug element 200, so that catch locking elements 202, 203, arranged on the plug element 200, come into engagement with an engaging catch 211 on the lock element 209 of the second module part 1b.

In the locked state the locking catch 211 of the lock element 209 is plugged into an insertion opening 213 of the plug-in element 200 and is catch-lockingly connected to the catch locking elements 202, 203 so that the first connecting module 1 cannot be removed from the second connecting module 2 counter to the closing direction X.

The catch locking elements 202, 203 are arranged on the plug element 200 of the second connecting module 2, wherein the catch locking elements 202, 203 are mounted elastically on the first module part 1a of the first connecting module 1 by spring elements 204, 205. This shall yet be further explained subsequently with the help of the embodiment according to FIGS. 11a to 11v.

The actuating element 208 is mounted on the lock element 209 shiftably via a slide guiding rail 210 along an unlocking direction Z, wherein the actuating element 208 can be pre-loaded into the position illustrated in FIG. 10c mechanically by using suitable spring means or magnetically by using suitable magnetic means.

In its basic manner of operation the lock device according to FIGS. 10a to 10f is similar to the embodiment of the lock device according to FIGS. 7a to 7g. The lock device can be opened, in that the second module part 1b, made of the lock element 209 and the actuating element 208, is pivoted on the rotation axis D relative to the first module part 1a and moved in the opening direction Y on the rotation axis D. Hereby, the engaging catch 211 of the lock element 209 is moved relative to the catch locking elements 202, 203 and is brought out of engagement with these, so that the first connecting module 1 can be taken away from the second connecting module 2 as soon as the engaging catch 211 no longer engages with the catch locking elements 202, 203. This state is illustrated in FIG. 10f.

In the locked, closed state, illustrated in FIG. 10c, the actuating element 208 of the second module part 1b of the first connecting module 1 is positioned in a position in which it engages positive-lockingly via engaging elements 207 with locking elements 206 on the second connecting module 2 in such a way that the second module part 1b cannot be pivoted in the opening direction Y on the rotation axis D. In the closed position according to FIG. 10c the lock device is thereby locked and cannot readily be opened. In particular, the second module part 1b of the first connecting module 1 cannot be moved in the opening direction Y and thereby the engaging catch 211 can also not be removed from the area of the catch locking elements 202, 203.

In the closed, locked state of the lock device end stops 212 of the actuating element 208 on the end are in contact with the slide guiding rail 210 (see FIG. 10c).

The engaging elements 207 in this manner together with the locking elements 206 realize a locking device, which in the closed, locked state of the lock device blocks a movement of the second module part 1b of the first connecting module 1 in the opening direction Y and counteracts an opening of the lock device.

By shifting the actuating element 208 along the slide guiding rail 210 on the lock element 209 counter to the closing direction X the locking can be released by bringing the engaging elements 207 out of engagement with the locking elements 206 on the second connecting module 2.

The unlocked, but still closed state of the lock device is illustrated in FIG. 10d. The actuating element 208 has been moved in the unlocking direction Z, contrary to the closing direction X, and the engaging elements 207 have thereby been removed from the engagement with the locking elements 206.

After unlocking, the second module part 1b (made of the actuating element 208 and the lock element 209) can be pivoted in the opening direction Y on the rotation axis D—as illustrated in FIG. 10e—to in this manner bring the engaging catch 211 out of engagement with the catch locking elements 202, 203 and to release the mechanical catch locking engagement between the connecting modules 1, 2.

The released state, in which the connecting modules 1, 2 can be removed from each other, is illustrated in FIG. 10f.

An embodiment of a lock device, modified compared with the embodiment according to FIGS. 10a to 10f, is illustrated in FIGS. 11a to 11v in various views. Differences arise essentially in the design of the locking device. The manner of operation of the lock device is otherwise largely identical so that reference can be made to the previous specification.

FIGS. 11a to 11f show the lock device in the opened state prior to closing, FIGS. 11g to 11l show the lock device upon closing, FIGS. 11m to 11r show the lock device in the closed, locked state, FIGS. 11s and 11t show the lock device in the closed but unlocked state, and FIGS. 11u and 11v show the lock device in the yet again opened state.

The lock device according to FIGS. 11a to 11v differs from the lock device according to FIGS. 10a to 10f essentially in the design of the second module part 1b of the first connecting module 1. In contrast to the lock device according to FIGS. 10a to 10f, in the lock device according to FIGS. 11a to 11v the second module part 1b is designed in one piece with two elastic arms 214 arranged thereupon, which each carry an engaging element 207 for the engagement with a locking element 206 on the second connecting module 2.

To unlock the lock device from its closed, locked state (see FIGS. 11m to 11r) these arms 214 are pushed towards each other (see FIGS. 11s and 11t), so that the engaging elements 207 come out of engagement with the locking elements 206 on the second connecting module 2 and the second module part 1b can be pivoted in the opening direction Y on the rotation axis D and the engaging catch 211 can be brought out of engagement with the catch locking elements 202, 203 on the second connecting module 2 (see FIGS. 11u and 11v). In this opened state the first connecting module 1 can then be taken away counter to the closing direction X from the second connecting module, and the lock device can thereby be released.

The arms 214 are designed sufficiently flexible and guarantee a secure locking of the lock device in the closed, locked state. The arms 214 with the engaging elements 207 arranged thereupon at the same time guarantee an automatic locking upon establishing the closing state of the lock device, when a suitable pre-loading of the second module part 1b—mechanic or magnetic or caused by gravity—into the position illustrated in FIGS. 11a to 11e is provided.

This return can for example be caused by magnets 3, 4, arranged on the second module part 1b and on the second connecting module 2, which magnetically attract each other upon the transfer of the lock device into the closing state and thereby on the one hand support the closing movement and on the other hand automatically cause a return of the second module part 1b into the position illustrated in FIGS. 11a to 11f.

Alternatively, the return can also be caused by a return anchor 31 (see FIG. 11f), arranged on the first module part 1a of the first connecting module 1, in the form of a ferromagnetic anchor (or by a corresponding return magnet) and the magnet 3, arranged on the second module part 1b, which magnetically attract each other and thereby automatically cause a return of the second module part 1b into the position illustrated in FIGS. 11a to 11f.

As the locking device has to be unlocked by actuating both arms 214 (namely by a pushing towards each other of these two arms 214) to open the lock device, the closing state of the lock device is securely locked and reliably secured against an unintended opening.

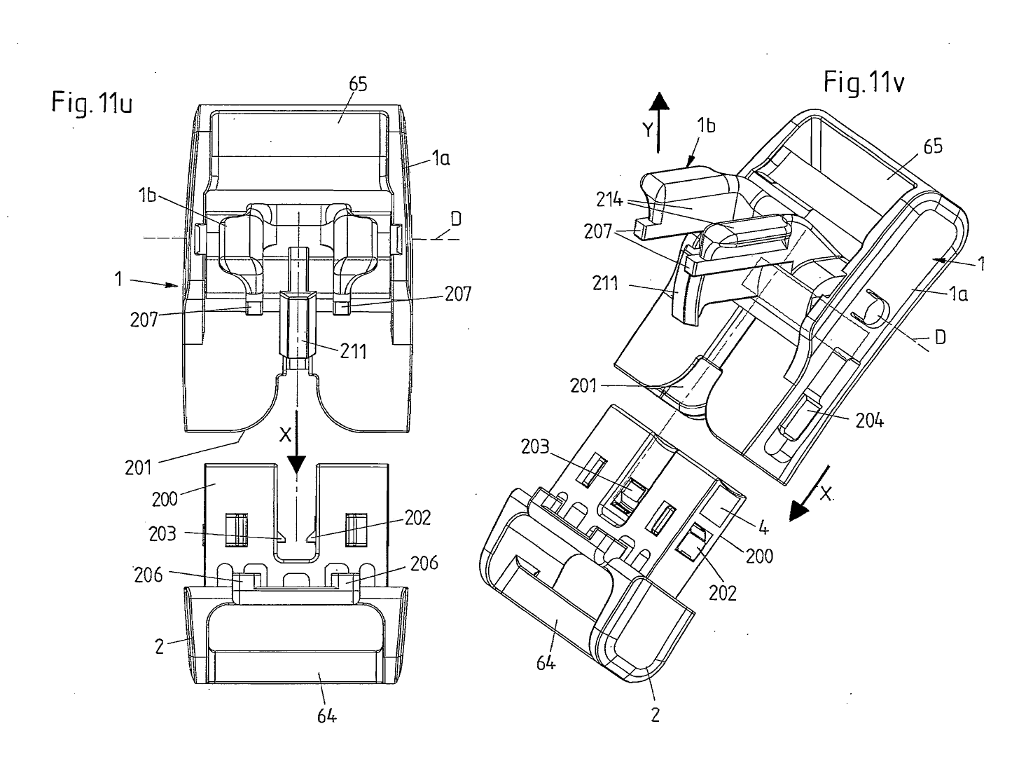

FIGS. 11g to 111 show the lock device upon transferring the connecting modules 1, 2 into their closing state. As already mentioned previously, the catch locking elements 202, 203 are arranged shiftably on the second connecting module 2, but here not mounted directly elastic on the second connecting module 2. The elastic mounting of the catch locking elements 202, 203 for the realization of the spring lock element 5 rather takes place via spring elements 204, 205, which are provided on the first module part 1a of the first connecting module 1. This has the purpose to make possible an easy mechanical catch-locking engagement of the connecting modules 1, 2 upon the transferring into the closing state, but at the same time to provide a secure, highly enduring mechanical catch locking engagement when the closing state is established.

To transfer the lock device into its closing state the first connecting module 1 is attached with the housing 201 arranged thereupon onto the plug element 200 of the second connecting module 2. Herein, the engaging catch 211 is inserted into the insertion opening 213 on the plug element 200 until the engaging catch 211 enters into contact with the catch locking elements 202, 203, which are shiftably arranged transverse to the closing direction X on the second connecting module 2.

As the catch locking elements 202, 203 are not pre-loaded against the second connecting module 2, but instead are arranged smoothly shiftable on the second connecting module 2, the engaging catch 211 can upon contact with the catch locking elements 202, 203, for the time being, shift these readily outwards and thereby move past the locking catches, designed on the catch locking elements 202, 203.

Upon further plugging the first connecting module 1 onto the plug element 200, however, the spring elements 204, 205 come into contact with the catch locking elements 202, 203 on the rear side and pre-load these inwards in a direction towards each other in such a way that, after the engaging catch 211 has moved past the catch locking elements 202, 203, the positive-locking engagement of the engaging catch 211 with the catch locking elements 202, 203 is automatically established.

As the engaging catch 211 enters into contact with the catch locking elements 202, 203, when these are not yet (or not yet completely) loaded by the spring elements 204, 205, the force required to establish the mechanical catch locking engagement can be reduced, which has the effect that the magnets 3, 4 of the connecting modules 1, 2, serving to support the closing movement, can, where applicable, be dimensioned smaller.

By suitable adjustment of the spring elements 204, 205, the catch locking elements 202, 203 and the engaging catch 211 to each other, a tilting upon establishing the closing state can, moreover, be prevented, wherein in the closing state, by the spring elements 204, 205 acting upon the catch locking elements 202, 203, the mechanical catch locking engagement is securely established in the closing state. The result is a smooth and haptically pleasant closing process with automatic or almost automatic catch locking engagement.

In the closed, locked state, illustrated in FIGS. 11m to 11r, the catch locking elements 202, 203 then engage positive-lockingly with the engaging catch 211 in such a way that the first connecting module 1 cannot be removed counter to the closing direction X from the second connecting module 2 without the second module part 1b to unlock and to open having been actuated.

The idea underlying the invention can basically also be realized in other embodiments. In particular, the invention is independent of the movement of the lock device which is to be carried out for actuation, which can take place rotating, tilting or shifting, wherein the connecting modules are either shifted against each other as a whole or are actuated via an actuating device.

The additional locking device can be designed as a simply designed locking element, but also as a combination lock or as a lock which is actuated by a key.

Depending on the embodiment, the restoring means can cause the automatic return of the locking device into the locking position, for example by a pre-loading mechanical spring, by magnetic means or by gravity.

Also, the return of the connecting modules into a position, in which a catch-locking engagement to establish the closing position is possible, can take place by additional restoring means, for example by using a mechanical spring, or also, as specified above, by the magnetic effect of the magnets (or anchors) provided anyway or by gravity.

Furthermore, instead of the magnetic means, other pre-loading, force-generating means can also be used, for example by means of spring means, or gravity or an actuation force or a momentum can be made use of.

In other words: a mechanical lock is provided, which catch-lockingly closes by attaching a first connecting module onto a second connecting module in a closing direction by force action (magnetic force, spring force, gravity), wherein the first connecting module cannot readily be taken away counter to this closing direction from the second connecting module, but instead, to open, is to be moved in an opening direction, differing from the closing direction, wherein a locking device prevents the shifting of the connecting modules relative to each other in a locking position, but can be unlocked to open the lock.

A lock device of the specified kind is suited for a multitude of different uses and can be employed advantageously. In this way the lock device can be employed as a lock for bags, backpacks, suitcases, furniture or other storage or transport means or containers. The lock device can moreover be employed for the detachable connection of components or flexible tension means such as ropes or straps (e.g. for mountain climbing equipment or sailing equipment or also for dog collars, tow ropes or other ropes or cords), for fastening motorcycle or bicycle accessories onto a motorcycle or a bicycle (as e.g. for fastening saddlebags or other bags or pouches, tools or the like) or for baby car seats, strollers or child carriers. Moreover, the lock device can be employed for fastening mobile phones, weapons, truncheons or other utensils (e.g. for the police) onto a belt holder.

This list is herein in no way restrictive. Essentially, an application of a lock device of the kind specified is possible and advantageous everywhere, where an easily closing, but at the same time in the closed state securely locked and enduring lock is desired.

### LIST OF REFERENCE SIGNS

1 First connecting module
1a First module part
1a′ Rotation core
1a″ Rotary knob carrier
1b Second module part
2 Second connecting module
3, 3a, 3b Magnet
4, 4a, 4b Magnet
5, 5a, 5b, 5c Spring lock element
6, 6a, 6b, 6c Blocking piece
7 Locking element
8 Locking recess
9, 9a-f Locking element
10, 10a-f Return spring
11, 11a-f Actuating bolt
12a, b, c, d Guiding rail
13 Guiding rail
14a-f Recess
15a-f Recess
17 Unlocking button
18 Plugging section
19 Recess
19a, 19b Run-up slope
19c Unlocking section
20 Base plate
21 Recess
22 Plug housing
23 Module part
230 Recess
231 Housing opening
30, 40 Back iron
50a, 50b, 50c Locking catch
51a, 51b Spring legs
52a, 52b Run-up slope
53 Recess
64, 65 Strap link
90 Recess
100 Ring shoulder
101 Groove
102 Locking element
103 Recess
104 Holding element
105, 106 Module part
107 Handle element
108 Housing collar
109 Recess
110 Bars
111 Grooves
112, 113 Parts
114 Housing
115 Collar
116, 117, 118 Opening
200 Plug element
201 Housing
202, 203 Catch locking element
204, 204 Spring element
206 Locking element
207 Engaging element
208 Actuating element
209 Lock element
210 Slide guiding rails
211 Engaging catch
212 End stop
213 Insertion opening
214 Arms
D Swivel axis
V Shifting direction
X Closing direction
Y Opening direction
Z Unlocking direction

1. Lock device, having
a first connecting module and a second connecting module, wherein the first connecting module can be arranged in a closing direction on the second connecting module and is in a closing position mechanically catch-lockingly engaged with the second connecting module,
wherein the first connecting module can be detached from the second connecting module by a movement of the first connecting module or of a part of the first connecting module in an opening direction, which differs from the closing direction,
characterized by
an unlockable locking device (7; 9, 9a-f; 100, 101, 102; 206, 207) to prevent a movement of the first connecting module (1) or of the part (1a) of the first connecting module (1) in the opening direction (Y), when the first connecting module (1) and the second connecting module (2) are positioned in the closing position.

2. Lock device according to claim 1, characterized in that the opening direction (Y) is not directed parallel to the closing direction (X).

3. Lock device according to claim 1 or 2, characterized in that the movement in the opening direction (Y) is a shifting movement transverse to the closing direction (X), a rotation movement in a plane transverse to the closing direction (X) or a pivoting movement on a rotation axis (D) transverse to the closing direction (X).

4. Lock device according to any of claims 1 to 3, characterized in that on the one of first connecting module (1) and second connecting module (2) at least one spring lock element (5, 5a, 5b, 5c) and on the other of first connecting module (1) and second connecting module (2) at least one blocking piece (6, 6a, 6b) to form a spring catch locking is arranged.

5. Lock device according to claim 4, characterized in that to release the first connecting module (1) from the second connecting module (2) the first connecting module (1) or the part (1a) of the first connecting module (1) can be moved relative to the second connecting module (2) in such a way that the at least one spring lock element (5, 5a, 5b, 5c) and the at least one blocking piece (6, 6a, 6b, 6c) of the spring catch locking come out of engagement.

6. Lock device according to claim 4 or 5, characterized in that to release the first connecting module (1) from the second connecting module (2) the at least one spring lock element (5, 5a, 5b, 5c) and the at least one blocking piece (6, 6a, 6b, 6c) of the spring catch locking are shifted relative to each other in such a way that the at least one spring lock element (5, 5a, 5b, 5c) along the opening direction (Y) gets out of range of the at least one blocking piece (6, 6a, 6b, 6c).

7. Lock device according to claim 4 or 5, characterized in that to release the first connecting module (1) from the second connecting module (2) the at least one spring lock element (5, 5a, 5b, 5c) and the at least one blocking piece (6, 6a, 6b, 6c) of the spring catch locking are shifted relative to each other in such a way that the at least one spring lock element (5, 5a, 5b, 5c) is pushed out of engagement with the at least one blocking piece (6, 6a, 6b, 6c) by running up onto a run-up slope (19a, 19b; 52a, 52b) transverse to the opening direction (Y).

8. Lock device according to claim 4 or 5, characterized in that the at least one spring lock element (5, 5a, 5b, 5c) and the at least one blocking piece (6, 6a, 6b, 6c) of the spring catch locking are designed as a kind of thread in such a way that by turning the first connecting module (1) or the part (1a) of the first connecting module (1) relative to the second connecting module (2) the at least one spring lock element (5, 5a, 5b, 5c) and the at least one blocking piece (6, 6a, 6b, 6c) of the spring catch locking can be screwed out of engagement.

9. Lock device according to any of the preceding claims, characterized by magnetic means (3, 4) which, to support the transferring of the first connecting module (1) into the closing position, cause a magnetic attracting force between the first connecting module (1) and the second connecting module (2).

10. Lock device according to claim 9, characterized in that the magnetic means (3, 3a, 3b, 4, 4a, 4b) are designed in such a way that by the movement in the opening direction (Y) the magnetic attracting force between the first connecting module (1) and the second connecting module (2) is weakened.

11. Lock device according to claim 9 or 10, characterized in that for the realization of the magnetic means at least one magnet (3, 3a, 3b, 4, 4a, 4b) each, or on the one hand at least one magnet (3, 3a, 3b, 4, 4a, 4b) and on the other hand at least one magnetic anchor, are arranged on the first connecting module (1) and on the second connecting module (2), respectively.

12. Lock device according to claim 11, characterized in that by the movement in the opening direction (Y) the at least one magnet (3, 3a, 3b) or the magnetic anchor of the first connecting module (1) and the at least one magnet (4, 4a, 4b) or the magnetic anchor of the second connecting module (2) are moved relative to each other in such a way that the magnetic attracting force weakens.

13. Lock device according to any of the preceding claims, characterized by restoring means to transfer the first connecting module (1) or the part (1a) of the first connecting module (1) into a position, in which the first connecting module (1) can be catch-lockingly engaged with the second connecting module (2).

14. Lock device according to claims 10 and 13, characterized in that the magnetic means (3, 3a, 3b, 4, 4a, 4b) act as restoring means.

15. Lock device according to any of the preceding claims, characterized in that the locking device has at least one locking element (7, 9, 9a-9f), movably arranged on the first connecting module (1) or on a part (1a, 1b) of the first connecting module (1), to engage with a recess (8) on the second connecting module (2) or on a second part (1b, 1a) of the first connecting module (1) in such a way that a movement of the first connecting module (1) or of the part of the first connecting module (1) in the opening direction (Y) to release the first connecting module (1) from the second connecting module (2) is prevented.

16. Lock device according to any of the preceding claims, characterized in that the locking device (7, 9, 9a-9f) is designed to be actuated by means of a key or a numerical code.

17. Lock device according to any of the preceding claims, characterized in that the locking device (7, 9, 9a-9f) is designed to automatically lock upon arranging the first connecting module (1) on the second connecting module (2).

18. Lock device according to any of the preceding claims, characterized in that the locking device (100, 101, 102; 206, 207) can be unlocked by moving the first connecting module (1) or a part (107; 208; 214) of the first connecting module (1) in an unlocking direction (Z).

19. Lock device according to claim 18, characterized in that the unlocking direction (Z) differs from the opening direction (Y) and is not directed parallel to it.

20. Lock device according to claim 18, characterized in that the unlocking direction (Z) differs from the opening direction (Y) and from the closing direction (X) and is not directed parallel to these.

21. Lock device according to any of claims 18 to 20, characterized in that the locking device is formed by a locking element (102) which is arranged on the first or the second connecting module (1, 2) and which in a locked, closed state of the lock device engages with a groove (101) on the other of first and second connecting module (1, 2).

22. Lock device according to claim 21, characterized in that the opening direction (Y) is directed transverse to the closing direction (X), and the unlocking direction (Z) is designed as a direction of rotation around the closing direction (X), wherein by turning the first connecting module (1) or a part (107) of the first connecting module (1) in the unlocking direction (Z) the locking element (102) can be disengaged from the groove (101).

23. Lock device according to any of claims 18 to 20, characterized in that the first connecting module (1) or a part (1b) of the first connecting module (1) can be pivoted relative to the second connecting module (2) on a rotation axis (D), directed transverse to the closing direction (X), in the opening direction (Y), wherein the locking device (7; 206, 207) in the locked state prevents a pivoting movement of the first connecting module (1) or of a part (1b) of the first connecting module (1).

24. Lock device according to claim 23, characterized in that the locking device is formed by a locking element (206), arranged on the one of first and second connecting module (1, 2), and an engaging element (207) which is arranged on the other of first and second connecting module (1, 2) and which in the locked state engages with the locking element (206), wherein the locking device (206, 207) can be unlocked by moving the first connecting module (1) or a part (208; 214) of the first connecting module (1) in an unlocking direction (Z), which differs from the opening direction (Y) and is not directed parallel to said opening direction (Y).

25. Lock device according to claim 24, characterized in that the unlocking direction (Z) is directed transverse to or contrary to the closing direction (X).
